(19) United States
(12) Patent Application Publication
(10) Pub. No.: US 2014/0318489 A1
(43) Pub. Date: Oct. 30, 2014

(54) EM ENERGY APPLICATION FOR COMBUSTION ENGINES

(71) Applicants: Shlomo Ben-Haim, London (GB); Amichai Ron, Jerusalem (IL); Elliad Silcoff, Tel Aviv (IL); Ginat Rachel Muginstein, Even Yehuda (IL); Steven Robert Rogers, D.N. Emek Sorek (IL); Pinchas Einziger, Haifa (IL)

(72) Inventors: Shlomo Ben-Haim, London (GB); Amichai Ron, Jerusalem (IL); Elliad Silcoff, Tel Aviv (IL); Ginat Rachel Muginstein, Even Yehuda (IL); Steven Robert Rogers, D.N. Emek Sorek (IL); Pinchas Einziger, Haifa (IL)

(73) Assignee: GOJI LTD., Hamilton (BM)

(21) Appl. No.: 13/981,267

(22) PCT Filed: Jan. 24, 2012
(86) PCT No.: PCT/US12/22392

§ 371 Date: Feb. 2, 2014

Related U.S. Application Data
(60) Provisional application No. 61/436,314, filed on Jan. 26, 2011.
(60) Provisional application No. 61/473,392, filed on Apr. 8, 2011.
(60) Provisional application No. 61/435,430, filed on Jan. 24, 2011.

(51) Int. Cl. F02P 23/00

(52) U.S. Cl. CPC F02P 23/00
USPC 123/143 R; 701/102

(57) ABSTRACT

An apparatus for igniting a fuel mixture by applying EM energy is disclosed. The apparatus may include a radiating element configured to apply EM energy to the fuel mixture at a plurality of Modulation Space Elements (MSEs), and a processor configured to determine at least one target spatial distribution of EM energy to be achieved during application of EM energy to the fuel mixture for igniting the fuel mixture, select a subset of MSEs from among the plurality of MSEs the subset of MSEs being selected to provide the at least one target spatial distribution, and cause application of EM energy to the fuel mixture at the selected subset of MSEs, via the at least one radiating element, to provide the at least one target spatial distribution of EM energy application.

### RELATED APPLICATIONS

The present application claims the benefit of priority from the following U.S. Provisional Patent Applications: No. 61/435,430 filed Jan. 24, 2011; No. 61/436,314 filed Jan. 26, 2011; and No. 61/473,392 filed Apr. 8, 2011; the entire contents of each being incorporated herein by reference.

### TECHNICAL FIELD

This is an International pated patent application relating to a device and method for applying electromagnetic (EM) energy, and more particularly, but not exclusively, to devices and methods for applying EM energy to various systems and applications in combustion engines, e.g., internal or external combustion engines.

### BACKGROUND

EM waves have been used in various applications to supply energy to objects. The waves may be supplied using a magnetron, typically tuned to a single frequency.

For example, RF energy may be used to produce fuel ignition in combustion engines (e.g., to replace the spark ignition of a gasoline engine). Combustion of fuel (e.g., fossil fuel) occurs when the fuel is mixed with an oxidizer (such as air) and ignited in a combustion chamber. Ignition of the fuel can be used to drive pistons, turbine blades, or a nozzle, for example. The basic component of combustion engines (e.g., diesel or gasoline powered combustion engines) is a cylinder with a piston. In diesel engines, ignition occurs spontaneously due to heat and pressure created by the engine in a compression of the fuel mixture, as long as threshold amounts of fuel air mixture and pressure are met. Ignition will not occur below the threshold amounts. Ignition in diesel engines may occur at several places within a cylinder simultaneously and controlled via timing fuel injection to the cylinder. In gasoline engines, the fuel mixture may be ignited using an electric spark. Ignition can be controlled via timing the application of the electric spark.

RF energy ignition, in place of such an electric spark, in gasoline engines is known. The RF energy may be transferred, for example, via an antenna to a gas mixture, ionizing the mixture thereby enhancing oxidation. RF energy carried by waves may release energy more quickly and in larger volumes than electric sparks. Energy application to fuel may be accomplished by creating a field pattern having one or more high intensity areas, also known as hot spots. For example, RF energy at a frequency of 2.54 GHz the hot spot may have the size of few cm³. HCCI (Homogeneous charge compression ignition) technology combines the benefits of volumetric spontaneous high compression ignition of diesel engines with production benefits and ignition homogeneity of gasoline engines. As in homogeneous charge spark ignition, fuel and oxidizer are mixed together. The density and temperature of the mixture may be then raised by compression until the entire mixture reacts spontaneously. HCCI engines may use lean fuel mixtures to minimize uncontrolled release of energy. The technology has many advantages' including: fuel saving, operation using diesel-like compression ratios (>15), low emissions of NOₓ). HCCI engines can be operated with gasoline fuel, diesel fuel or alternative fuels. However, the HCCI technology has several disadvantages. For example, CO and hydrocarbons or soot emissions per-cycle are relatively high. Further, high pressure may cause damage to the engine. Another significant limitation in HCCI technology is the lack of control of ignition timing, especially when flexible torque is needed in cold start or acceleration. To achieve dynamic operation in an HCCI engine, the control system must change the conditions that induce combustion: the fuel mixture, the compression ratio and/or the temperature of the fuel mixture on a cycle by cycle basis for every cylinder in the engine. Variable Valve Actuation (VVA) may give finer control over the temperature-pressure-time history within the combustion chamber by controlling the point at which an intake valve closes and the amount of hot exhaust gas retained in the combustion chamber (cylinder). The sensors in the cylinder may apply signals to a processor that adjusts the VVA system at every cycle based on temperature, pressure and the movement of the piston.

Power can be increased by introducing more fuel into the combustion chamber of combustion engines. However, in HCCI engines the fuel mixture may burn nearly simultaneously. Another method applied in experimental GM HCCI engines is to run the engine in HCCI mode only at partial load conditions and run the engine as a diesel or spark ignition engine at full or near full load conditions.

Gas Turbines add energy to a gas stream in a burner or a combustor where fuel is mixed with air and ignited. Combustion of the fuel increases the temperature. Products of combustion may be forced into a turbine section where high velocity and volume of the gas flow is directed through a nozzle over turbine blades, spinning the turbine. For some turbines, this power drives mechanical output. Unlike in gasoline or diesel engines, ignition may occur once at the initiation of the turbine. However, the ignited flame must be controlled and stabilized in an anchor point to obtain efficiency of the fuel combustion. It is also important to avoid flame penetration into the main channel flow (i.e., blowout). There are several methods to stabilize and anchor the flame in gas or dual-fuel (gas and fuel oil) turbines. For example, mixers, swirl generators and aerodynamic flame stabilizers, may be added. Another approach is to add catalytic converter (catalyzer) to the burner. For example, catalytic modules may be localized at the entrance of a burnout zone that may act as preferred location for the initiation of the oxidation of the fuel. This may further allow lowering the temperature of the combustion reaction bellow 1500° C. thus avoiding the formation of NOₓ, CO or unburned hydrocarbon emissions. Using catalyzer for anchoring the flame may allow the use of lean fuel mixtures thus reducing emission of NOₓ. However, lean mixtures may cause fluctuations in the size and location of the flame. Some approaches combine the benefits of both the flow modeling approach and the catalyzer, using the catalyzer as a mixer, a swirl generator and/or an aerodynamic flame stabilizer. One of the major challenges in flame anchoring is to stabilize the flame under variation in the fuel mixture, for example, in lean fuel mixtures or in a hybrid turbine.

### SUMMARY

Some exemplary aspects of the disclosure include apparatuses and methods for applying EM energy to various combustion engines. For example for stabilizing the anchor point of a flame ignited in a combustion chamber in gas turbine. Some other aspects may be directed to the application of EM energy to ignite fuel mixtures in combustion chambers, for example igniting fuel mixtures injected to a cylinder in an internal combustion engine. EM energy may further be applied to pre-heat a fuel or a fuel mixture prior to ignition, optionally to enhance the ignition.

Some embodiments of the invention may be related to apparatuses and methods for applying EM energy to stabilize an anchor point of a flame. The apparatus may include at least one radiating element configured to apply EM energy to the flame in a turbine. The methods may be performed by a processor.

In some embodiments the processor may be configured to determine at least one spatial distribution of EM energy to be achieved during application of EM energy to the flame. The processor may control the application of EM energy to the flame, via the at least one radiating element such that the at least one spatial distribution of EM energy is applied for stabilizing the anchor point of the flame. In some embodiments the processor may determine the spatial distribution based on a feedback. The feedback may be related to: at least one aspect to the flame, at least one aspect of a combustion chamber comprising the flame or at least one aspect of the turbine. The EM energy application may be controlled based on the feedback.

In some embodiments EM energy may be applied to stabilize the anchor point of the flame, at a subset of MSEs. The processor may be configured to select a subset of Modulation Space Elements (MSEs) from among a plurality of MSEs at which EM energy from the at least one radiating element can be applied. The processor may further control the application of EM energy to the flame, via the at least one radiating element such that the EM energy is applied for stabilizing the anchor point of the flame. In some embodiments the subset of MSEs may be selected based on a feedback. Optionally the processor may select the subset, such that the selected subset of MSEs being selected to provide the at least one spatial distribution of EM energy.

In some embodiments the processor may be configured to receive a feedback, from at least the flame or the turbine. The processor may further control the EM energy application, via the at least one radiating element, for stabilizing the anchor point of the flame based on the feedback. The feedback may be related to at least on aspect of the flame or the turbine.

Some exemplary embodiments of the invention may be directed to an apparatus and method for igniting a fuel mixture by applying EM energy, for example to a combustion chamber. The apparatus may comprise at least one radiating element configured to apply EM energy to the fuel mixture at a plurality of Modulation Space Elements (MSEs) and at least one processor. The method may be performed by the processor. The processor may be configured to determine at least one spatial distribution of EM energy to be achieved during application of EM energy to the fuel mixture for igniting the fuel mixture. EM energy may be controlled and applied to the fuel mixture via the at least one radiating element, to provide the at least one spatial distribution of EM energy application.

In some embodiments, the processor may be configured to select a subset of MSEs from among the plurality of MSEs. Optionally, the subset of MSEs being selected to provide the at least one spatial distribution and to cause the application at the selected subset of MSEs. In some embodiments, the processor may be configured to cause the application of the EM energy to the fuel mixture, via the at least one radiating element. In some embodiments, the processor may be configured to cause the application of the EM energy at the subset of MSEs to the fuel mixture, via the at least one radiating element.

In some embodiments, the processor may be further be configured to determine the spatial distribution and/or select the subset of MSEs based on feedback. The feedback may be a feedback related to at least one aspect of the fuel mixture. The feedback may be received from a combustion chamber containing the fuel mixture and/or an engine comprising the combustion chamber. The feedback may be received during at least one combustion cycle. The feedback may be relating to at least one of: a temperature of a fuel mixture in a chamber, a temperature of a portion of the chamber, geometry of the chamber, a relative position of an engine component or a composition of the fuel mixture in the chamber. The feedback may be an EM feedback. Optionally, the EM feedback may be received from the combustion chamber and/or may be indicative of EM energy absorbable in the fuel mixture. The EM feedback may be based at least partially on a calculation or estimation.

In some embodiments, the processor may be configured to control the EM energy application, based on the feedback. For example, the processor may determine at least one amount of EM energy to be applied to the fuel mixture based on the feedback. The processor may set time duration and/or a power level at which EM energy is to be applied to the fuel mixture based on the feedback. The processor may further be configured to control the timing of the EM energy application according to the feedback, for example according to a relative position of the engine component.

In some other embodiments, the processor may control the EM application to the fuel mixture based on the determined spatial distribution and/or the selected subset of MSEs and/or the received feedback.

Some aspects of the invention may include determining the at least one spatial distribution of EM energy by determining an amount of EM energy to be absorbed by the fuel mixture in at least a portion of a volume in the combustion chamber. In some embodiments, the processor may determine a first EM spatial energy profile configured such that EM energy may be selectively applied to the fuel mixture in a first portion of a combustion chamber and a second spatial EM energy profile configured such that EM energy is selectively applied to the fuel mixture in a second portion of the combustion chamber. The processor may further be configured to cause absorption of EM energy at the first spatial EM energy profile during a first time period, and to cause EM energy absorption at the second spatial EM energy profile during a second time period, wherein at least a portion of the second time period does not overlap with the first time period. Optionally, a timing of causing application of the EM energy is based on a relative position of a piston in a cylinder.

In some embodiments, determining spatial distribution and/or selecting subset of MSEs and/or controlling the EM energy application may be based on at least one aspect associated with ignition of the fuel mixture, for example when the ignition occurs in accordance with one or more ignition states associated with engine operation. The ignition states may be related to one of a cold start ignition of an engine, acceleration of an engine and cruise driving. In some embodiments, the processor may determine spatial distribution and/or may select subset of MSEs and/or may control the EM energy application to affect an amount of fuel consumed during a cold start ignition of an engine or to affect torque during acceleration of an engine.

Some other aspects of the invention may include applying the EM energy to the fuel mixture such that substantially complete combustion of the fuel mixture may occur. In some embodiments, the fuel mixture may be a lean fuel mixture. Fuel mixtures according to some embodiments of the invention may include absorbing material. Some apparatuses may include an injector configured to inject EM absorbing material into the fuel mixture.

In some embodiments, the apparatus disclosed above may be installed in a combustion engine, optionally the combustion engine may be a part of a vehicle. The combustion engine may be is selected from a group consisting of: a diesel engine, a gasoline engine or a HCCI engine.

In some embodiments, the EM application to the fuel mixture may provide a desired temperature to the fuel mixture to control a timing of ignition of the fuel mixture. In some embodiments, ignition of the fuel mixture may be performed in sub-threshold compression.

Some aspects of the invention may include applying EM energy to a fuel mixture in a combustion chamber, via at least one radiating element configured to apply the EM energy to the fuel mixture in the combustion chamber. An EM feedback may be received and/or determined. The EM feedback may be associated with one or more portions of the combustion chamber. In some embodiments, a plurality of EM field patterns through which the EM energy is to be applied to the fuel mixture in the combustion chamber may be determined. A weight may be determined for each of the plurality of EM field patterns, based on the EM feedback. The plurality of EM field patterns may be excited at the determined weights via the at least one radiating element to apply the EM energy to the fuel mixture in the combustion chamber.

Some embodiments of the invention may include an apparatus and method for heating fuel or fuel mixture prior to ignition of the fuel. EM energy may be applied to the fuel via at least one radiating element configured to apply EM energy to the fuel or the fuel mixture. The EM application may occur prior to an injection of the fuel or the fuel mixture into a combustion chamber, optionally as the fuel flows through a pipe. Alternatively, The EM energy may be applied to the fuel or the fuel mixture as the fuel or the fuel mixture is in a combustion chamber prior to ignition.

The method may be performed by at least one processor. The processor may be configured to determine at least one spatial distribution of EM energy to be achieved during application of EM energy to the fuel or fuel mixture. Additionally or alternatively, the processor may be configured to select a subset of Modulation Space Elements (MSEs) from among a plurality of MSEs at which EM energy from the at least one radiating element can be applied. Optionally, the selected subset of MSEs being selected to provide the at least one target spatial distribution of EM energy. The processor may control the application of EM energy to the fuel or fuel mixture, via the at least one radiating element, based on the selected subset of MSEs and/or the determined spatial distribution of EM energy to heat the fuel prior to ignition of the fuel. The preheated fuel may be injected to a cylinder in a combustion engine.

In some embodiments, the determining spatial distribution and/or selecting a subset of MSEs may be based on a feedback. The feedback may be related to at least one aspect of the fuel or fuel mixture, one aspect of a fuel system, or one aspect of an engine comprising the fuel system. The feedback may be related to at least one of a temperature of the fuel, a temperature of a portion of the fuel system, geometry of the fuel system, a position of a component of an engine, or a composition of the fuel. The feedback may be received during at least one combustion cycle.

In some embodiments, the processor may be configured to control the EM energy application, based on the feedback. Optionally, the feedback may be an EM feedback. The EM feedback may be received from a chamber containing the fuel mixture or a pipe containing the fuel. For example, the processor may determine at least one amount of EM energy to be applied to the fuel based on the feedback. The processor may set time duration and/or a power level at which EM energy is to be applied to the fuel or the fuel mixture based on the feedback. The processor may further be configured to control the timing of the EM energy application according to the feedback, for example according to a relative position of a piston in a cylinder. The controller may further be configured to predetermine an amount of energy to be applied to the fuel or the fuel mixture, optionally to heat the fuel or the fuel mixture to a target temperature, wherein the target temperature affects a timing of ignition of the fuel.

Some aspects of the invention may include applying EM energy to a fuel prior to ignition to affect an amount of free radicals in the fuel.

In some embodiments, the fuel system may be installed in a combustion engine, optionally the combustion engine may be a part of a vehicle. The combustion engine may be is selected from a group consisting of: a diesel engine, a gasoline engine or a HCCI engine.

Some aspects of the invention may include a fuel mixture comprising: a combustible fuel compound and an EM energy absorbing material mixed with the combustible fuel component. The EM energy absorbing material being selected to at least one of enhance EM energy absorption by the fuel mixture or to affect one or more ignition characteristics of the fuel mixture. The fuel mixture may be a lean fuel mixture.

The drawings and detailed description which follow contain numerous alternative examples consistent with the invention. A summary of every feature disclosed is beyond the object of this summary section. For a more detailed description of exemplary aspects of the invention, reference should be made to the drawings, detailed description, and claims, which are incorporated into this summary by reference.

### BRIEF DESCRIPTION OF THE DRAWINGS

FIG. 1 is a diagrammatic representation of an apparatus for applying EM energy to an object, in accordance with some exemplary embodiments of the present invention;

FIG. 2 is a view of a cavity, in accordance with some exemplary embodiments of the present invention;

FIG. 3 is a flowchart of a method for applying EM energy to an energy application zone based on a feedback, in accordance with some embodiments of the invention;

FIG. 4 is a diagrammatic representation of an apparatus for applying EM energy to an object, in accordance with some exemplary embodiments of the present invention;

FIG. 5A is a flow chart of a method for exciting a predetermined spatial energy distribution in an energy application zone, in accordance with some exemplary embodiments of the present invention;

FIG. 5B is an illustration of three electromagnetic field patterns in accordance with some embodiments of the invention

FIG. 6 is a flowchart of a method for applying EM energy to an energy application zone, in accordance with some embodiments of the invention;

FIG. 7 is an exemplary burner in a gas turbine, in accordance with some embodiments of the invention;

FIG. 8 is a flowchart of a method for applying EM energy to stabilized a flame in an anchor point, in accordance with some embodiments of the invention;

FIG. 9 shows simulation results of EM field excited when an EM energy is applied to a flame in a turbine;

FIG. 10 is a diagrammatic representation of a cylinder, in accordance with some exemplary embodiments of the present invention;

FIG. 11 presents a method for applying EM energy to a fuel mixture in a combustion engine in accordance with some embodiments of the invention;

FIG. 12 illustrates a model of a gasoline cylinder comprising an RF wave guide for applying EM energy to the cylinder, in accordance with some embodiments of the invention;

FIGS. 13A-13F present temperature profile that may developed in a gasoline cylinder having air/fuel ratio of 14:1 due to excitation of EM wave with a frequency of 10.45 GHz, in accordance with some embodiments of the invention;

FIGS. 14A-14F present temperature profile that may developed in a gasoline cylinder having air/fuel ratio of 14:1 due to excitation of EM wave with a frequency of 16.95 GHz, in accordance with some embodiments of the invention;

FIGS. 15A-15C present temperature profile that may developed in a gasoline cylinder having air/fuel ratio of 100:1 due to excitation of EM wave with a frequency of 16.95 GHz, in accordance with some embodiments of the invention;

FIG. 16 shows variation in S11 parameter as a function of frequency of the EM energy for different fuel mixture ratios and air, in accordance with some embodiments of the invention;

FIG. 17A illustrates a cylinder in accordance with some embodiments of the invention;

FIG. 17B shows the reflection coefficient (S11 parameter) for different piston positions simulated for a 14:1 fuel mixture ratio, in accordance with some embodiments of the invention;

FIG. 17C shows the mean value of the S11 parameter versus the piston position, in accordance with some embodiments of the invention; and

FIG. 17D shows the S11 parameter for a particular frequency (11.1 GHz) versus the piston position, in accordance with some embodiments of the invention; and

FIG. 18 presents a method for applying EM energy to a heat a fuel or a fuel mixture prior to ignition in a combustion chamber in accordance with some embodiments of the invention.

### DETAILED DESCRIPTION

Reference will now be made in detail to exemplary embodiments of the invention, examples of which are illustrated in the accompanying drawings. When convenient, the same reference numbers are used throughout the drawings to refer to the same or like parts.

In one respect, the invention may involve apparatus and methods for applying EM (EM) energy to a fuel (e.g., fossil fuel) or a fuel mixture (e.g., fossil fuel and air) to heat and optionally ignite the fuel or the fuel mixture. Some other aspects may include applying EM energy to anchor a flame ignited in a turbine.

Flame Anchoring

In some embodiments, EM energy may be applied to a combustion chamber in a gas turbine (also known as combustion turbine) in order to stabilize the anchor point of a flame in the turbine. The flame may be ignite and maintained by a burner configured to produce a flame in a combustion chamber. In some embodiments, EM energy may be applied to the combustion chamber in gas turbine in order to avoid flame out (blowout of the flame). In some embodiments, the flame may be stabilized to increase the combustion efficiency, e.g., when lean fuel mixtures are used. The use of lean fuel mixtures in gas turbine may decrease the fuel consumption and may reduce NOₓ, CO or unburned hydrocarbon emissions, due to low combustion temperatures (e.g., below 1500° C.). However, lean mixture flames tend to vibrate in intensity and location in the burner, a phenomena known as “combustion oscillations”, and anchoring the flame may be more difficult (compared to non-lean fuel mixture). In some embodiments, EM energy may be applied to the turbine in order to obtain ignition and flame stabilization at lower air/fuel ratios, e.g., in order to optimize (reduce) fuel consumption.

In some embodiments, EM energy may be applied to a lean fuel mixture in a burner to stabilize the flame, optionally while reducing the amount of fuel in the fuel mixture. In some embodiments, the amount of fuel in a fuel mixture may be reduced when EM energy is applied in order to stabilize the anchor point of a flame in the turbine. Additionally or alternatively, the EM energy application may reduce the combustion oscillations and may also reduce the risk of a blowout. In some embodiments, the EM energy application may control the state, position (location), shape, intensity level or temperature of the flame. In some embodiments, EM energy may be applied in order to control the state, position (location), shape, intensity level or temperature of the flame.

In some embodiments of the invention, EM energy may be applied in gas turbine for creating a preferred location for the initiation of fuel oxidation and flame. In some embodiments, this may be flexible to change dynamically and may react to variations in fuel mixture, flame temperature and/or gas emissions.

The term EM energy, as used herein, includes any or all portions of the EM spectrum, including but not limited to, radio frequency (RF), infrared (IR), near infrared, visible light, ultraviolet, etc. In one particular example, applied EM energy may include RF energy with a wavelength in free space of 100 km to 1 mm, which corresponds to a frequency of 3 KHz to 300 GHz, respectively. In some other examples, the applied EM energy may fall within frequency bands between 500 MHz to 1500 MHz or between 700 MHz to 1200 MHz or between 800 MHz-1 GHz. Microwave and ultra high frequency (UHF) energy, for example, are both within the RF range. While examples of the invention may be described herein in connection with the application of RF energy, these descriptions are illustrative and not meant to be limit the invention to any particular portion of the EM spectrum.

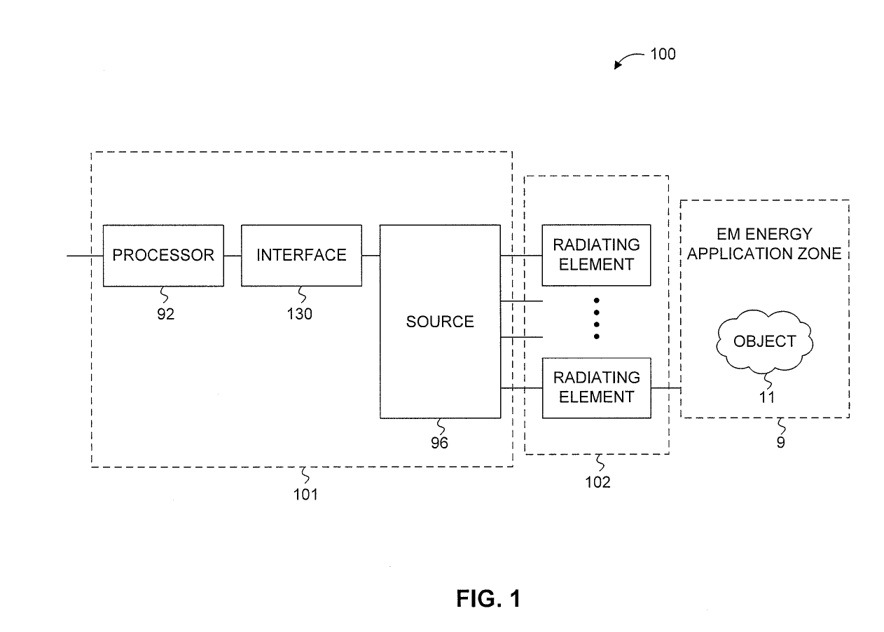

In certain embodiments, application of EM energy may occur in a combustion chamber, (e.g., the combustion chamber in a turbine or in a cylinder) or in a fuel system other device related to a combustion engine. Application of EM energy to the combustion chamber or the fuel system may occur, for example, in an “energy application zone 9.” An exemplary energy application zone 9 is shown in FIG. 1. Energy application zone 9 may include any void, location, region, or area where EM energy may be applied. Energy application zone 9 may be hollow, or may be filled or partially filled with liquids, solids, gases, or mixtures thereof. Energy application zone 9 may include an interior of an enclosure, interior of a partial enclosure, that allows existence, propagation, and/or resonance of waves of EM radiation together with carrying out a chemical reaction, for example combustion of fuel. For purposes of this disclosure, energy application zones 9 may alternatively and equivalently be referred to as “cavities.” An object may be considered “in” energy application zone 9 if at least a portion of the object is located in the zone or if some portion of the object receives EM radiation from zone 9.

In accordance with some embodiments of the invention, an apparatus or method may involve the use of at least one source configured to apply EM energy to energy application zone 9. A “source” may include any component(s) that are suitable for generating and applying EM energy. Consistent with some embodiments of the invention, EM energy may be applied to the energy application zone in the form of propagating EM waves at predetermined wavelengths or frequencies (also known as “EM radiation”). As used consistently herein, “propagating EM waves” may include resonating waves, evanescent waves, and waves that travel through a medium in any other manner. EM radiation carries energy that may be imparted to matter.

In certain embodiments, EM energy may be applied to an object 11. References to an “object” (or “object to be heated”) to which EM energy is applied are not limited to a particular form or state of the object. For example, an object may include a liquid, semi-liquid, solid, semi-solid, or gas. The object may also include composites or mixtures of matter in differing phases. In some embodiments, the object may include fuel, a mixture of fuel and oxidizer, and/or the plasma zone of a flame. In some embodiments, the object may include EM particles.

A portion of EM energy applied to energy application zone 9 may be absorbed by object 11. Other portions of the EM energy applied to energy application zone 9 may be absorbed by various other elements (e.g., deposits, such as scale, at the walls of the zone 9, structures associated with zone 9, or other EM energy-absorbing materials found in zone 9) associated with energy application zone 9.

FIG. 1 is a diagrammatic representation of an apparatus 100 for applying EM energy to an object. Apparatus 100 may include an application and control system (e.g., controller 101), an array of radiating elements or energy sources (herein the terms “antenna,” radiating element” may be used interchangeably) 102 including one or more radiating elements, and energy application zone 9. Controller 101 may be electrically coupled to one or more radiating elements 102. As used herein, the term “electrically coupled” refers to one or more direct or indirect electrical connections. Controller 101 may include processor 92, an interface 130, and an EM energy source 96. Based on an output from processor 92, source 96 may respond by generating one or more radio frequency signals to be supplied to radiating elements 102. The one or more radiating elements 102 may radiate (apply) EM energy into energy application zone 9. In certain embodiments, this energy can interact with object 11 positioned within energy application zone 9.

Processor 92 may include a general purpose or special purpose computer. Processor 92 may be configured to generate control signals for controlling EM energy source 96 via interface 130. Processor 92 may further receive measured signals from EM energy application zone 9, optionally via interface 130.

While controller 101 is illustrated for exemplary purposes as having three subcomponents, control functions may be consolidated in fewer components, or additional components may be included consistent with the desired function and/or design of a particular embodiment.

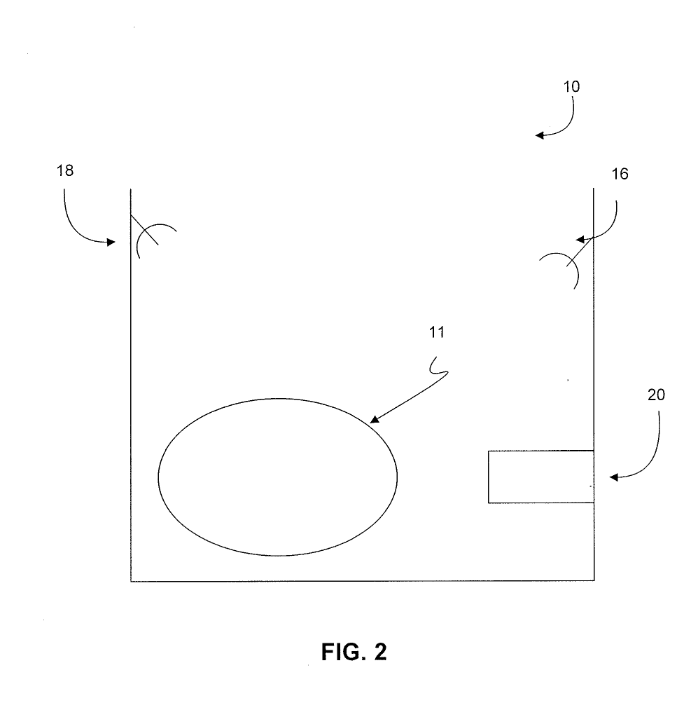

FIG. 2 shows a diagrammatic sectional view of a cavity 10, which is one exemplary embodiment of energy application zone 9. Cavity 10 may be cylindrical in shape (or take on any other suitable shape, such as semi-cylindrical, elliptical, among others) and may be made of a conductor, such as aluminum, stainless steel or any suitable metal or other electrically conductive material. In some embodiments, cavity 10 may include walls coated and/or covered with a protective coating, for example, made from materials transparent to EM energy (e.g., metallic oxides or others). In some embodiments, cavity 10 may include a cylinder in a combustion engine, a combustion chamber in a turbine or may be included in a fuel system. In some embodiments the cavity may include a burner for igniting and sustaining a flame. Cavity 10 may be resonant in a predetermined range of frequencies (e.g., within the UHF or microwave range of frequencies, such as between 300 MHz and 3 GHz, or between 400 MHz and 1 GHZ). Cavity 10 may be closed, e.g., completely enclosed (e.g., by conductor materials), bounded at least partially, or open, e.g., having non-bounded openings. The general methodology of the invention is not limited to any particular cavity shape or configuration.

FIG. 2 also shows an exemplary sensor 20 and radiating elements 16 and 18 as examples of radiating elements 102 (FIG. 1). In some embodiments, field adjusting element(s) (not illustrated) may be provided in energy application zone 9, for example, in cavity 10. Field adjusting element(s) may be adjusted to change the EM wave pattern in the cavity in a way that selectively directs the EM energy from one or more of radiating elements 16 and 18 into object 11. Additionally or alternatively, field adjusting element(s) may be further adjusted to match at least one of radiating elements 16 and 18 while acting as transmitters, and thus reduce coupling to other radiating elements acting as receivers.

In the presently disclosed embodiments, more than one feed and/or a plurality of radiating elements (e.g., radiating elements 102) may be provided. The radiating elements may be located on one or more surfaces of an enclosure defining the energy application zone 9. Alternatively or additionally, radiating elements may be located inside or outside the energy application zone 9. One or more of the radiating elements may be in contact with, in the vicinity of, or even embedded in object 11 (e.g., when the object is a liquid or gas) or immersed in fuel, such as fuel in a fuel chamber. In some embodiments, the radiating element may include a flame anchoring element, for example, when the flame anchoring element is comprised from a conductive material designed to apply and emit EM radiation. The orientation and/or configuration of each radiating element may be different. Each radiating element may be positioned, adjusted, and/or oriented to transmit EM waves to the energy application zone 9. The radiating elements may transmit EM energy along one direction or along multiple directions. In some embodiments, different elements may transmit EM energy along different directions. Furthermore, the location, orientation, and configuration of each radiating element may be determined before applying energy to the object. Alternatively or additionally, the location, orientation, and configuration of each radiating element may be dynamically adjusted, for example, by using a processor (e.g., processor 92), during operation of the apparatus and/or between rounds of energy application. It is to be understood that the invention is not limited to radiating elements having particular structures or locations.

As represented by FIG. 1, apparatus 100 may include at least one radiating element in the form of radiating element 102 for applying of EM energy to energy application zone 9. One or more of the radiating element(s) may also be configured to receive EM energy from energy application zone 9. A “radiating element,” as used herein, may function as a transmitter, a receiver, or both.

As used herein, the terms “radiating element” and “antenna” may broadly refer to any structure from which EM energy may radiate and/or be received, regardless of whether the structure was originally designed for the purposes of transmitting (e.g., radiating) or receiving energy, and regardless of whether the structure serves any additional or different function. Consistent with some exemplary embodiments, radiating elements 102 may include an EM energy transmitter (referred to herein as “a transmitting radiating element”) that applies energy into EM energy application zone 9, an EM energy receiver (referred herein as “a receiving radiating element”) that receives energy from zone 9, or a combination of both a transmitter and a receiver. For example, a first radiating element may be configured to apply EM energy to zone 9, and a second radiating element may be configured to receive energy from the first radiating element. In some embodiments, one or more radiating elements may each serve as both receivers and transmitters. In some embodiments, one or more radiating elements may serve a dual function while one or more other radiating elements may serve a single function. So, for example, a single radiating element may be configured to both apply EM energy to the zone 9 and to receive EM energy via the zone 9; a first radiating element may be configured to apply EM energy to the zone 9, and a second radiating element may be configured to receive EM energy via the zone 9; or a plurality of radiating elements could be used, where at least one of the plurality of radiating elements may be configured to both transmit EM energy to zone 9 and to receive EM energy via zone 9. At times, in addition to or as an alternative to transmitting and/or receiving energy, a radiating element may also be adjusted to affect the field pattern. For example, various properties of the radiating element, such as position, location, orientation, temperature, etc., may be adjusted. Different radiating element property settings may result in differing EM field patterns within the energy application zone thereby affecting energy absorption in the object. Therefore, radiating element adjustments may be varied in an energy application scheme.

Consistent with some of the presently disclosed embodiments, EM energy may be supplied to one or more transmitting radiating elements. Energy supplied to a transmitting radiating element may result in energy emitted (applied) by the transmitting radiating element (the emitted energy being referred to herein as “incident energy”). The incident energy may be applied to zone 9, and may be in an amount equal to an amount of energy supplied to the transmitting radiating element(s) by a source. A portion of the incident energy may be dissipated in the object or absorbed by the object 11 (referred to herein, respectively, as “dissipated energy” or “absorbed energy”). Another portion may be reflected back to the transmitting radiating element (referred to herein as “reflected energy”). Reflected energy may include, for example, energy reflected back to the transmitting radiating element due to mismatch caused by the object and/or the energy application zone, e.g., impedance mismatch. Reflected energy may also include energy retained by the port of the transmitting radiating element (e.g., energy that is emitted by the radiating element but does not flow into the zone). The rest of the incident energy, other than the reflected energy and dissipated energy may be coupled to one or more receiving radiating elements other than the transmitting radiating element (referred to herein as “coupled energy.”). Therefore, the incident energy (“I”) supplied to the transmitting radiating element may include dissipated energy (“D”), reflected energy (“R”), and coupled energy (“T”), and may be expressed according to the relationship:

I=D+R+ΣTᵢ.

In accordance with certain aspects of the invention, the one or more transmitting radiating elements 102 may apply EM energy into zone 9. Energy applied by a transmitting radiating element 102 into the zone 9 (referred to herein as “applied energy” or (d)) may be the incident energy emitted by the radiating element minus the reflected energy at the same radiating element. That is, the applied energy may be the net energy that flows from the transmitting radiating element to the zone 9, i.e., d=I−R. Alternatively, the applied energy may also be represented as the sum of dissipated energy and transmitted energy, i.e., d=D+T (where T=ΣTi).

In some embodiments, one or more slow wave antenna(s) may be provided in the energy application zone either in addition to or as an alternative to radiating element(s) 102. A slow-wave antenna or a near field radiating element may refer to a wave-guiding structure that possesses a mechanism that permits it to emit power along all or part of its length. The slow wave antenna or near field radiating element may comprise a plurality of slots to enable EM energy to be emitted. In some embodiments, the slow wave antenna or near field radiating element may be located in proximity to a pipe containing a fuel or a fuel mixture. One or more near field radiating elements may be aligned to one or more parts of the fuel system. In some embodiments, the near field radiating element may apply EM energy to the object by emitting evanescent waves.

In some embodiments, coupling may be formed between an evanescent EM wave (e.g., emitted from a slow wave antenna) and the object (e.g., the fuel or fuel mixture). An EM wave that is evanescent in free space (e.g., in the vicinity of the slow wave antenna) may be non-evanescent in the object.

Radiating elements (e.g., radiating element 102) may be configured to emit (apply) energy at specifically chosen modulation space elements, referred to herein as “MSEs,” which are optionally chosen by processor 92. The term “modulation space” or “MS” is used to collectively refer to all controllable parameters that may affect a field pattern in the energy application zone and all combinations thereof. In some embodiments, the “MS” may include possible controllable components that may be used and their potential settings (absolute and/or relative to others) and adjustable parameters associated with the components. For example, the “MS” may include a plurality of variable parameters, the number of radiating elements, their positioning and/or orientation (if modifiable), useable bandwidth of frequencies, a set of all useable frequencies and any combinations thereof, power settings, phases, etc. The MS may have any number of possible variable parameters, ranging between one parameter only (e.g., a one dimensional MS limited to frequency only or phase only—or other single parameter), two or more dimensions (e.g., varying frequency and amplitude or varying frequency and phase together within the same MS), or more.

Each variable parameter associated with the MS is referred to as an “MS dimension.” By way of example, a three dimensional modulation space, with three dimensions designated as frequency (F), phase (P), and amplitude (A). That is, frequency, phase, and amplitude (e.g., an amplitude difference between two or more waves being transmitted at the same time) of the EM waves are modulated during energy application, while all the other parameters may be predetermined and fixed during energy application, i.e., the modulation space is depicted in three dimensions for ease of discussion only. The MS may have any number of dimensions, e.g., one dimension, two dimensions, four dimensions, n dimensions, etc. In one example, a one dimensional modulation space may provide MSEs that differ one from the other only by frequency.

The term “modulation space element” or “MSE,” may refer to a specific set of values of the variable parameters in MS. Therefore, the MS may also be considered to be a collection of all possible MSEs. For example, two MSEs may differ one from another in the relative amplitudes of the energy being supplied to a plurality of radiating elements. For example, an MSE in a three-dimensional MS may have a specific frequency F(i), a specific phase P(i), and a specific amplitude A(i). If even one of these MSE variables changes, then the new set defines another MSE. For example, (3 GHz, 30°, 12 V) and (3 GHz, 60°, 12 V) are two different MSEs, although only the phase component is different.

Differing combinations of these MS parameters may lead to differing field patterns across the energy application zone and differing energy distribution patterns in the object. A plurality of MSEs that can be executed sequentially or simultaneously to excite a particular field pattern in the energy application zone may be collectively referred to as an “energy application scheme.” For example, an energy application scheme may consist of three MSEs: (F(1), P(1), A(1)); (F(2), P(2), A(2)) (F(3), P(3), A(3)). Such an energy application scheme may result in applying the first, second, and third MSE to the energy application zone.

The invention is not limited to any particular number of MSEs or MSE combinations. Various MSE combinations may be used depending on the requirements of a particular application and/or on a desired energy transfer profile, and/or given equipment, e.g., cavity dimensions. The number of options that may be employed could be as few as two or as many as the designer desires, depending on factors such as intended use, level of desired control, hardware or software resolution and cost.

In certain embodiments, there may be provided at least one processor (e.g., processor 92). As used herein, the term “processor” may include an electric circuit that performs a logic operation on input or inputs. For example, such a processor may include one or more integrated circuits, microchips, microcontrollers, microprocessors, all or part of a central processing unit (CPU), graphics processing unit (GPU), digital signal processors (DSP), field-programmable gate array (FPGA) or other circuit suitable for executing instructions or performing logic operations. The at least one processor may be coincident with or may be part of controller 101.

The instructions executed by the processor may, for example, be pre-loaded into the processor or may be stored in a separate memory unit such as a RAM, a ROM, a hard disk, an optical disk, a magnetic medium, a flash memory, other permanent, fixed, or volatile memory, or any other mechanism capable of storing instructions for the processor. The processor(s) may be customized for a particular use or may be configured for general-purpose use and can perform different functions by executing different software.

If more than one processor is employed, all may be of similar construction, or they may be of differing constructions electrically connected or disconnected from each other. They may be separate circuits or integrated in a single circuit. When more than one processor is used, the one or more processors may be configured to operate independently or collaboratively. They may be coupled electrically, magnetically, optically, acoustically, mechanically or by other means permitting them to interact.

The at least one processor may be configured to cause EM energy to be applied to zone 9 via one or more radiating elements, for example across a series of MSEs (a plurality of MSEs), in order to apply EM energy at each such MSE to object 11. For example, processor 92 may be configured to regulate one or more components of controller 101 in order to cause the energy to be applied.

In certain embodiments, the at least one processor may be configured to determine an EM feedback, e.g., a value indicative of energy absorbable by the object at each of a plurality of MSEs. The EM feedback may be MSE dependant. This may occur, for example, using one or more lookup tables, by pre-programming the processor or memory associated with the processor, and/or by testing an object in an energy application zone to determine its absorbable energy characteristics. One exemplary way to conduct such a test is through a sweep.

As used herein, a sweep may include, for example, the transmission over time of energy at more than one MSE. For example, a sweep may include the sequential transmission of energy at multiple MSEs in one or more contiguous MSE band; the sequential transmission of energy at multiple MSEs in more than one non-contiguous MSE band; the sequential transmission of energy at individual non-contiguous MSEs; and/or the transmission of synthesized pulses having a desired MSE/power spectral content (e.g., a synthesized pulse in time). The MSE bands may be contiguous or non-contiguous. Thus, during an MSE sweeping process, the at least one processor may regulate the energy supplied to the at least one radiating element to sequentially apply EM energy at various MSEs to zone 9, and to receive feedback which serves as an indicator of the energy absorbable by object 11. While the invention is not limited to any particular measure of EM feedback, some EM feedbacks may be indicative of energy absorption in the object, are discussed below.

During the sweeping process, EM source 96 (e.g., via a directional coupler) may be regulated to receive EM energy reflected and/or coupled at radiating element(s) 102, and to communicate the measured energy information (e.g., information pertaining to and/or related to and/or associated with the measured energy) back to processor 92 via interface 130, as illustrated in FIG. 1. Processor 92 may then be regulated to determine an EM feedback (e.g., a value indicative of energy absorbable by object 11) at each of a plurality of MSEs based on the received information. Consistent with some of the presently disclosed embodiments, an EM feedback indicative of the absorbable energy may include a DR associated with each of a plurality of MSEs. As referred to herein, a “dissipation ratio (DR)” (or “absorption efficiency” or “power efficiency”), may be defined as a ratio between EM energy absorbed by object 11 and EM energy supplied into the transmitting radiating element. In some embodiments, a “dissipation ratio (DR)”, may be defined as a ratio between EM energy absorbed by object 11 and EM energy applied into EM energy application zone 9.

Energy that may be dissipated or absorbed by an object is referred to herein as “absorbable energy” or “absorbed energy”. Absorbable energy may be an indicator of the object's capacity to absorb energy or the ability of the apparatus to cause energy to dissipate in a given object (for example, an indication of the upper limit thereof). In some of the presently disclosed embodiments, absorbable energy may be calculated as a product of the incident energy (e.g., maximum incident energy) supplied to the at least one radiating element and the dissipation ratio. Reflected energy (e.g., the energy not absorbed or transmitted) may, for example, be an EM feedback indicative of energy absorbable by the object. By way of another example, a processor might calculate or estimate absorbable energy based on the portion of the incident energy that is reflected and the portion that is coupled. That estimate or calculation may serve as a value indicative of absorbed and/or absorbable energy.

During an MSE sweep, for example, the at least one processor may be configured to control a source of EM energy such that energy is sequentially supplied to an object at a series of MSEs. The at least one processor might then receive a signal indicative of energy reflected at each MSE and, optionally, also a signal indicative of the energy coupled to other radiating elements at each MSE. Using a known amount of incident energy supplied to the radiating element and a known amount of energy reflected and/or coupled (e.g., thereby indicating an amount of energy absorbed at each MSE), an absorbable energy indicator may be calculated or estimated. Alternatively, the processor might simply rely on an indicator of reflection and/or transmission as a value indicative of absorbable energy.

In some of the presently disclosed embodiments, a dissipation ratio (DR) may be calculated using formula (1):

DR=(Pin−Prf−Pcp)/Pin (1)

where: Pin represents the EM energy and/or power supplied into zone 9 by radiating elements 102, Prf represents the EM energy and/or power reflected/returned at those radiating elements that function as transmitters, and Pcp represents the EM energy and/or power coupled at those radiating elements that function as receivers. DR may be a value between 0 and 1, and thus may be represented by a percentage.

For example, consistent with an embodiment which is designed for three radiating elements 1, 2, and 3, processor 92 may be configured to determine input reflection coefficients S11, S22, and S33 and the transfer coefficients may be S12=S21, S13=S31, S23=S32 based on a measured power and/or energy information during the sweep. Accordingly, the dissipation ratio DR corresponding to radiating element 1 may be determined based on the above mentioned reflection and transmission coefficients, according to formula (2):

DR=1−(IS11I2+IS12I2+IS13I2). (2)

The value indicative of the absorbable energy may further involve the maximum incident energy associated with a power amplifier (not illustrated) of source 96 at the given MSE. As referred herein, a “maximum incident energy” may be defined as the maximal power that may be provided to the radiating element at a given MSE throughout a given period of time. Thus, one alternative value indicative of absorbable energy may be the product of the maximum incident energy and the dissipation ratio. These are just two examples of values that may be indicative of absorbable energy which could be used alone or together as part of control schemes implemented in processor 92. Alternative indicators of absorbable energy may be used, depending for example on the structure employed and the application.

In certain embodiments, the at least one processor may also be configured to cause energy to be supplied to the at least one radiating element in at least a subset of a plurality of MSEs. Energy applied to the zone at each of the subset of MSEs may be a function of the absorbable energy value at the corresponding MSE. For example, energy transmitted to the zone at MSE(i) may be a function of the absorbable energy value at MSE(i). The energy supplied to at least one radiating element 102 at each of the subset of MSEs may be determined as a function of the absorbable energy value at each MSE (e.g., as a function of a dissipation ratio, maximum incident energy, a combination of the dissipation ratio and the maximum incident energy, or some other indicator). In some embodiments, the subset of the plurality of MSEs and/or the energy applied to the zone at each of the subset of MSEs may be determined based on or in accordance with a result of absorbable energy information (e.g., absorbable energy feedback) obtained during an MSE sweep (e.g., at the plurality of MSEs). That is, using the absorbable energy information, the at least one processor may adjust energy supplied at each MSE such that the energy at a particular MSE may in some way be a function of an indicator of absorbable energy at that MSE. The functional correlation may vary depending upon application and/or a desired target effect, e.g., a more uniform spatial energy distribution may be desired across object 11. The invention is not limited to any particular scheme, but rather may encompass any technique for controlling the energy supplied by taking into account an indication of absorbable energy.

In certain embodiments, the at least one processor may be configured to cause energy to be supplied to the at least one radiating element in at least a subset of the plurality of MSEs. The subset of MSEs at which energy is applied may be selected based on various criteria. For example, in some embodiments, the subset of MSEs may be selected such that energy application is concentrated spatially within a certain region or regions of the energy application zone (e.g., to obtain a target spatial distribution of EM energy). In other embodiments, the subset of MSEs may be selected such that energy application may result in substantially uniform energy absorption by an object in the energy application zone. Further, in some embodiments, energy applied to the zone at each of the subset of MSEs may be inversely related to the EM feedback (e.g., value indicative of energy absorbable) at the corresponding MSE. Such an inverse relationship may involve a general trend (e.g., when an EM feedback in a particular MSE subset (i.e., one or more MSEs) tends to be relatively high, the actual incident energy at that MSE subset may be relatively low). When an EM feedback in a particular MSE subset tends to be relatively low, the incident energy may be relatively high. This substantially inverse relationship may be even more closely correlated. For example, the applied energy may be set such that its product with the EM feedback (i.e., the absorbable energy by object 11) is substantially constant across the MSEs applied.

Some exemplary energy application schemes may lead to more spatially uniform energy absorption in the object. As used herein, “spatial uniformity” may refer to a condition where the absorbed energy across the object or a portion (e.g., a selected portion) of the object that is targeted for energy application is substantially constant (for example per volume unit or per mass unit). In some embodiments, the energy absorption is considered “substantially constant” if the variation of the dissipated energy at different locations of the object is lower than a threshold value. For instance, a deviation may be calculated based on the distribution of the dissipated energy in the object, and the absorbable energy is considered “substantially constant” if the deviation between the dissipation values of different parts of the object is less than 50%. Because in many cases spatially uniform energy absorption may result in spatially uniform temperature increase, consistent with the presently disclosed embodiments, “spatial uniformity” may also refer to a condition where the temperature increase across the object or a portion of the object that is targeted for energy application is substantially constant. The temperature increase may be measured by a sensing device, for example a temperature sensor provided in zone 9. In some embodiments, spatial uniformity may be defined as a condition, where a given property of the object is uniform or substantially uniform after processing, e.g., after a heating process. Examples of such properties may include temperature, pressure, hazardous compounds emissions, load and torque of an engine etc.

In order to achieve control over the spatial distribution of energy absorption in an object or a portion of an object (e.g. to achieve spatial uniformity or controlled spatial non-uniformity), processor 92 may be configured to hold substantially constant the amount of time at which energy is supplied to radiating elements 102 at each MSE, while varying the amount of power supplied at each MSE as a function of the absorbable energy value. In some embodiments, controller 101 may be configured to cause the energy to be supplied to the radiating element at a particular MSE or MSEs at a power level substantially equal to a maximum power level of the device and/or the amplifier at the respective MSE(s).

Alternatively or additionally, processor 92 may be configured to vary the period of time during which energy is applied to each MSE as a function of the EM feedback at each MSE or other feedback. At times, both the duration and power at which each MSE is applied are varied as a function of the EM feedback at that MSE. Varying the power and/or duration of energy supplied at each MSE may be used to cause substantially uniform energy absorption in the object or to have a controlled spatial distribution of energy absorption, for example, based on feedback (e.g., feedbacks other than EM feedbacks) from the object at each applied MSE.

Because absorbable energy can change based on factors including object temperature, in some embodiments, it may be beneficial to regularly update EM feedbacks and adjust energy application based on the updated EM feedbacks. These updates can occur multiple times a second, or can occur every few seconds or longer, depending on the requirements of a particular application.

In accordance with an aspect of some embodiments of the invention, the at least one processor (e.g., processor 92) may be configured to determine a desired and/or target energy absorption level at each of a plurality of MSEs and adjust energy supplied from the radiating element at each MSE in order to obtain the target energy absorption level at each MSE. For example, processor 92 may be configured to target a desired energy absorption level at each MSE in order to achieve or approximate substantially uniform energy absorption across a range of MSEs. Alternatively, processor 92 may be configured to provide a target energy absorption level at each of a plurality of object portions, which collectively may be referred to as an energy absorption profile across the object. An absorption profile may include uniform energy absorption in the object, non-uniform energy absorption in the object, differing energy absorption values in differing portions of the object, substantially uniform absorption in one or more portions of the object, or any other desirable pattern of energy absorption in an object or portion(s) of an object.

In some embodiments, the at least one processor may be configured to adjust energy supplied to the radiating element at each MSE in order to obtain a desired target energy effect in the object, e.g., to obtain a target spatial EM energy distribution, for example: a different amount of energy may be provided to different parts and/or regions of the object or the combustion chamber (e.g., a different amount of energy may be applied to different location within the combustion chamber).

One or more sensor(s) (or detector(s)) 20 may be used to sense, or detect, transmit, relate, derive and/or determine “feedback” (described in more detail below and referred to herein interchangeably as “feedback” and “feedback information”) relating to object 11 and/or to the energy application process and/or the energy application zone or any other object, device or location described herein. At times, one or more radiating elements, e.g., radiating element 16 or 18, may be used as sensors 20 (e.g., when acting as receivers). The feedback information may include EM feedback (e.g., EM signals may be detected).

Sensor(s) 20 may be installed, for example, in or around energy application zone 9 or in or around object 11. As used herein, the words “sensor” and “detector” refer generally to a device configured to detect a certain aspect of the device's environment and/or of an object in the device's environment. Suitable sensors 20 may detect any environmental aspect that may be useful in the determination and/or regulation of EM energy applied to the object 11. For example, sensor 20, may detect, collect, process, send, and/or receive information relating to “feedback,” as described below. Sensor or sensors 20 may also detect, collect, process, send, and/or receive information that does not relate to feedback (e.g., timing of various processes, various environmental conditions not related to the application of EM energy). Sensors 20 may include thermocouples or IR sensors. In some exemplary embodiments sensor(s) 20 may include a pressure gauge (e.g., a barometer), for measuring gas pressure, a piezoelectric gauge for measuring movements and oscillations, a speedometer, a torque meter, a camera (e.g., a visual light or UV or IR camera) for detecting a size or a location of an object (e.g., a flame), etc.

As used herein, the term “feedback” generally refers to information in any suitable form (e.g., in the form of signals, electronic or otherwise, code, data, digital or analog, etc.) relating to any aspect of the environment of object 11 (including object 11 itself) that may or may not be affected by or affect by applications of EM energy. Feedback may include or be derived from various parameters and/or information that is not necessarily associated with the application of EM energy (referred to herein simply as “feedback”). Alternatively, feedback may include feedback that is received via EM radiation or via apparatuses, methods relating to the application and/or collection of EM radiation (referred to herein as “EM feedback”). As used herein, EM feedback may include any received signal or any value calculated based on a receive signal(s), which may be indicative of the dielectric response of the cavity and/or the object to the applied RF energy. In this case the EM feedback may include various parameters and/or information associated with the application, reflection, transmission and/or absorption of EM energy by object 11, apparatus 100, the environment in proximity to any of sensor 20, object 11, or apparatus 100 or any other device or entity described herein. Alternatively or in addition, feedback may include various parameters and/or information that is not necessarily associated with the application of EM energy (referred to herein simply as “feedback”). Feedback sensed, detected, transmitted, related, derived and/or determined by sensor 20 may be continuous or may be sensed, detected, transmitted, related, derived and/or determined in discreet increments or events.

Feedback may include, for example, temperatures or information relating to a temperature of object 11, apparatus 100, the environment in proximity to any of the sensor 20, the object 11, and the apparatus 100 or any other device or entity described herein. Feedback may also include, for example, materials parameters relating to object 11, apparatus 100, the environment in proximity to any of the sensor 20, the object 11, and the apparatus 100 or any other device or entity described herein, such as materials parameters, for example, that may relate to a change of state, a decrease/increase in any intrinsic or extrinsic property, change in mass, weight, density, size, color, chemical constitution, shape (e.g., aspect ratio, volume, etc.), conductivity, a state or states of a chemical reaction (e.g., combustion) and/or chemical reactivity. The feedback may relate to fluid properties relating to the object 11, and the apparatus 100 or any other device or entity described herein. Such fluid properties may include, for example, a gas or liquid flow rate, humidity, pressure (e.g., a barometer, pressure of an exhaust gas in or from an engine), pH, presence of particles or ions in the fuel mixture or the flame, etc.

Any of the above-described forms of feedback may relate, for example, to a location and/or volume of the flame in the combustion chamber. The above-described feedback may also relate to, for example, a temperature of the flame or a plasma zone in the flame. Alternatively, or in addition, the above-described feedback may also relate to a composition of a component in an environment of object 11, for example, the feedback may relate to a composition of a gas included in object 11. The gas may include, for example, an exhaust gas from a combustion in a turbine or a cylinder, and the composition included in the feedback may relate to an amount of exhaust or other specific component of the exhaust gas. The feedback may also relate to any other property described herein (e.g., temperature, density, etc.).

EM feedback may include any received signal or any value calculated based on a receive signal(s), for example from sensor(s) 20. EM feedback may be MSE-dependent, for example, and may include signals, the values of which vary over different MSEs. EM feedback may relate to, for example, a dissipation ratio (referred to herein as “DR”) of the object 11 or other entity in the vicinity of the object 11. The value indicative of absorbable energy may or may not relate to the DR. For example, the DR and/or the EM feedback may relate to an incident power of EM energy, a reflected power of EM energy, a coupled power of EM energy and/or a ratio there between (e.g., such as via a reflection coefficient or a transfer coefficient). EM feedback may also or alternatively include, for example, input and output power levels, scattering parameters (a/k/a S parameters) and values derivable from the S parameters and/or from the power levels, for example, input impedance of one or more radiating element, dissipation ratio, time or MSE derivative of any of them, or any other value that may be derivable from the received signals.

EM feedback may relate to, for example, use and/or construction of a loss profile. A loss profile may include any representation of the ability of an energy application zone 9 or object 11 to absorb energy, such as EM energy applied from apparatus 100. A loss profile may include a spatial distribution within an object or a cavity (and a portion thereof). A loss profile may be represented, for example, by a matrix, table or other 2D or 3D representation or map of a cavity, wherein each portion of the map may be annotated (e.g., using notations, cross-hatching, colors, etc.) in accordance with the ability of that portion to absorb energy. In the case of an energy application zone (e.g., zone 9), a loss profile may include such representation across its volume with or without an object 11.

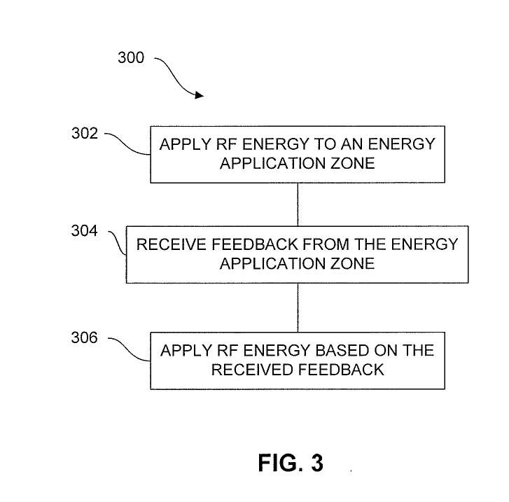

Method 300 for applying EM energy, e.g., Radio Frequency (“RF”) energy—EM energy from radiation in the RF range) to an energy application zone (e.g., energy application zone 9, FIG. 1) is presented in the flowchart in FIG. 3. EM energy may be applied to the energy application zone (e.g., zone 9), at step 302, via one or more radiating elements. In some embodiments, low amounts of EM energy may initially be applied at one or more MSEs. Low EM amounts of energy may be defined as amounts of energy applied to the energy application zone that are too low to process an object (e.g., object 11) placed in the zone. For example, the low amounts of energy may not be sufficient to process the object 11. As use herein an amount of energy sufficient to process an object is defined as an amount of energy, that when applied to the object may change at least one property of the object in at least a portion of the object (e.g., to cook a food item, thaw frozen object, cause or accelerate a combustion, heat an fuel or fuel mixture or a pipe containing the fuel or fuel mixture, or to anchor a flame in a turbine, etc.). Low amounts of energy may be applied, for example, by applying low EM power from the EM source (e.g., source 96) or by applying a high power for short periods of time. Alternatively, EM energy application in step 302 may be conducted in energy levels sufficient to process an object in the energy application zone 9. The EM energy application in step 302 may be conducted by sweeping over a plurality of MSEs, for example, by transmission over time of energy at more than one MSE. A processor (e.g., processor 92) may control the EM energy application by sweeping over a plurality of MSEs and assigning a constant (e.g., low) amount of energy to be applied at each MSE.

The processor may than receive a feedback (e.g., EM feedback) from the energy application zone or from a system comprising the energy application zone, at step 304. The feedback may be received from one or more sensors, for example a thermometer placed in zone 9. An EM feedback may be a result of the EM energy applied at step 302. The EM feedback may be received from one or more sensors and/or detectors configured to measure EM feedback values in the energy application zone 9 (e.g., sensor 20). The EM feedback may include any type of feedback discussed above. Various EM feedback values may be received by the processor (e.g., processor 92) during application of EM energy at various MSEs, for example during sweeping over a plurality of MSEs. The processor 92 may be configured to associate each EM feedback value with a corresponding MSE. Additionally or alternatively, other feedback values (not related to EM feedback) may be received during application of EM energy at various MSEs, for example during sweeping over a plurality of MSEs. Each of the received feedback (or EM feedback) values may be associated with a particular MSE.

The processor may further be configured to apply EM energy based on the received feedback, at step 306. For example, the processor may cause application of EM energy at selected MSEs (e.g., MSEs associated with a feedback values lower or higher than a threshold). Additionally or alternatively, the processor may adjust the EM energy amounts applied at each MSE as a function of the EM feedback value at that MSE. In some exemplary embodiments, the processor may apply EM energy at each MSE in an amount inversely related to or nearly inversely related to the dissipation ratio value at that MSE.

In some embodiments, the at least one processor may determine a weight, used for supplying a determined amount of energy at each MSE. Determining the weight may include determining a power level and/or time duration for each EM energy application. In some embodiments, such weights may be determined as a function of the EM feedback (e.g., value indicative of absorbable energy). For example, an amplification ratio of an amplifier may be changed with the EM feedback values received from zone 9 at each MSE. In some embodiments, the processor may use the maximum available power at each MSE, which may vary between MSEs. This variation may be taken into account when determining the respective durations at which the energy is supplied at maximum power at each MSE. In some embodiments, the at least one processor (e.g., processor 92) may determine both the power level and time duration for supplying the energy at each MSE.

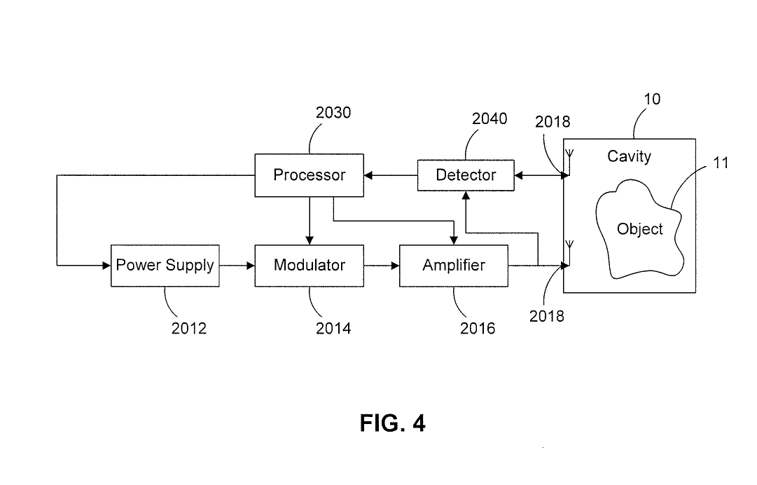

FIG. 4 provides a diagrammatic representation of an exemplary apparatus 100 for applying EM energy to an object, in accordance with some embodiments of the present invention. In accordance with some embodiments, apparatus 100 may include a processor 2030 which may regulate modulations performed by modulator 2014. In some embodiments, modulator 2014 may include at least one of a phase modulator, a frequency modulator, and an amplitude modulator configured to modify the phase, frequency, and amplitude of the AC waveform, respectively. Processor 2030 may alternatively or additionally regulate at least one of location, orientation, and configuration of each radiating element 2018, for example, using an electro-mechanical device. In some embodiments, the processor may be configured to select at least one radiating element from a plurality of radiating elements. The processor may be further configured to connect or disconnect the at least one selected radiating element. Connecting or disconnecting may be performed by mechanical means (e.g., moving or shifting a waveguide or a coaxial cable from one radiating element to the other) or by electric switching between the selected elements (e.g., by providing zero power to the disconnected radiating element), or by any other suitable method or configuration for switching between one or more radiating elements. Such an electromechanical device may include a motor or other movable structure for rotating, pivoting, shifting, sliding or otherwise changing the orientation and/or location of one or more of radiating elements 2018. Alternatively or additionally, processor 2030 may be configured to regulate one or more field adjusting elements located in the energy application zone, in order to change the field pattern in the zone.

In some embodiments, apparatus 100 may involve the use of at least one source configured to supply EM energy to at least one radiating element. By way of example, and as illustrated in FIG. 4, the source may include one or more of a power supply 2012 configured to generate EM waves that carry EM energy. For example, power supply 2012 may be a magnetron configured to generate high power microwave waves at a predetermined wavelength or frequency. Alternatively, power supply 2012 may include a semiconductor oscillator, such as a voltage controlled oscillator, configured to generate AC waveforms (e.g., AC voltage or current) with a constant or varying frequency. AC waveforms may include sinusoidal waves, square waves, pulsed waves, triangular waves, or another type of waveforms with alternating polarities. Alternatively, a source of EM energy may include any other power supply, such as EM field generator, EM flux generator, solid state amplifier or any mechanism for generating vibrating electrons.

Referring back to FIG. 4, in some embodiments, apparatus 100 may include a frequency modulator (not illustrated). The frequency modulator may include a semiconductor oscillator configured to generate an AC waveform oscillating at a predetermined frequency. The predetermined frequency may be in association with an input voltage, current, and/or other signal (e.g., analog or digital signals). For example, a voltage controlled oscillator may be configured to generate waveforms at frequencies proportional to the input voltage.

Processor 2030 may be configured to regulate an oscillator (not illustrated) to sequentially generate AC waveforms oscillating at various frequencies within one or more predetermined frequency bands. In some embodiments, a predetermined frequency band may include a working frequency band, and the processor may be configured to cause the transmission of energy at frequencies within a sub-portion of the working frequency band. A working frequency band may be a collection of frequencies selected because, in the aggregate, they achieve a desired goal, and there is diminished need to use other frequencies in the band if that sub-portion achieves the goal. Once a working frequency band (or subset or sub-portion thereof) is identified, the processor may sequentially apply power at each frequency in the working frequency band (or subset or sub-portion thereof). This sequential process may be referred to as “frequency sweeping.” In some embodiments, each frequency may be associated with a feeding scheme (e.g., a particular selection of MSEs). In some embodiments, based on the feedback (e.g., EM feedback) provided by detector 2040, processor 2030 may be configured to select one or more frequencies from a frequency band, and regulate an oscillator to sequentially generate AC waveforms at these selected frequencies.

Alternatively or additionally, processor 2030 may be further configured to regulate amplifier 2016 to adjust amounts of energy applied via radiating elements 2018, based on a feedback, e.g., detector 2040 may detect an amount of energy reflected from the energy application zone and/or energy coupled (to other radiating element) at a particular frequency.

In some embodiments, the apparatus may include more than one EM energy generating component. For example, more than one oscillator may be used for generating AC waveforms of differing frequencies. The separately generated AC waveforms may be amplified by one or more amplifiers. Accordingly, at any given time, radiating elements 2018 may be caused to simultaneously transmit EM waves at, for example, two differing frequencies to cavity 10.

In some embodiments, apparatus 100 may include a phase modulator (not illustrated) that may be controlled to perform a predetermined sequence of time delays on an AC waveform, such that the phase of the AC waveform is increased by a number of degrees (e.g., 10 degrees) for each of a series of time periods. In some embodiments, processor 2030 may dynamically and/or adaptively regulate modulation based on feedback from the energy application zone 9. For example, processor 2030 may be configured to receive an analog or digital feedback signal from detector 2040, indicating an amount of EM energy received from cavity 10, and processor 2030 may dynamically determine a time delay at the phase modulator for the next time period based on the received feedback signal.

Processor 2030 may be configured to regulate the phase modulator in order to alter a phase difference between two EM waves emitted to the energy application zone 9. In some embodiments, the source of EM energy may be configured to supply EM energy in a plurality of phases, and the processor may be configured to cause the application of energy at a subset of the plurality of phases. By way of example, the phase modulator may include a phase shifter. The phase shifter may be configured to cause a time delay in the AC waveform in a controllable manner within cavity 10, delaying the phase of an AC waveform anywhere from between 0-360 degrees.

In some embodiments, a splitter (not illustrated) may be provided in apparatus 100 to split an AC signal, for example generated by an oscillator, into two AC signals (e.g., split signals). Processor 2030 may be configured to regulate the phase shifter to sequentially cause various time delays such that the phase difference between two split signals may vary over time. This sequential process may be referred to as “phase sweeping.” Similar to the frequency sweeping described above, phase sweeping may involve a working subset of phases selected to achieve a desired energy application goal.

The processor may be configured to regulate an amplitude modulator in order to alter an amplitude of at least one EM wave supplied to the energy application zone 9. In some embodiments, the source of EM energy may be configured to supply EM energy in a plurality of amplitudes, and the processor may be configured to cause the application of energy at a subset of the plurality of amplitudes. In some embodiments, the source may be configured to apply EM energy through a plurality of radiating elements, and the processor may be configured to supply energy with differing amplitudes simultaneously to at least two radiating elements.

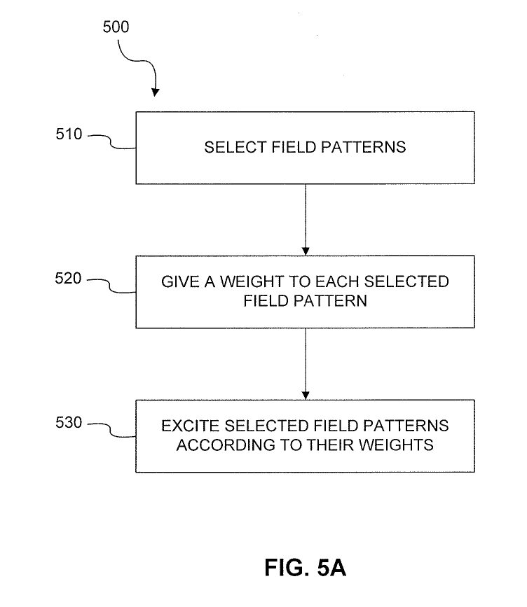

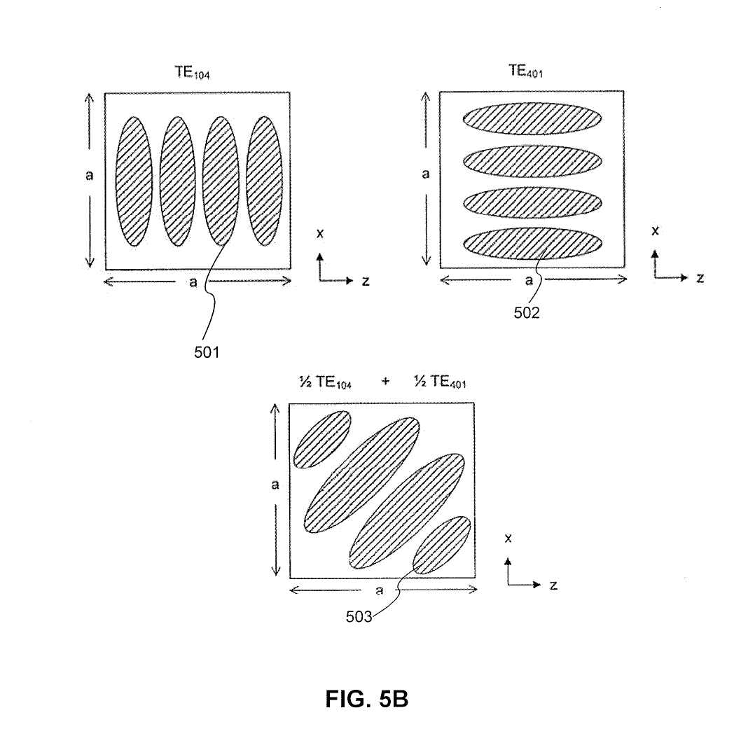

FIG. 5A is a flowchart of an exemplary method 500 of applying a spatial EM energy distribution to energy application zone 9, by exciting a target EM field intensity distribution in the energy application zone. In some embodiments, exciting a target EM energy distribution may be achieved by determining weights associated with field patterns. As shown in FIG. 5A, method 500 may include selecting one or more field patterns, as indicated in step 510. The selection may be based on a target EM field intensity distribution. The selection may be from multiple EM field patterns available to the apparatus (e.g., apparatus 100). The EM field patterns may be predetermined or may be determined based on a feedback from zone 9 (e.g., an EM feedback). Additionally or alternatively, the EM field patterns may include at least two linearly independent field patterns. Optionally, the EM field patterns may also include linear combinations of two or more modes. In some embodiments, step 510 is carried out by a processor (e.g., processor 92 or 2030). For example, the processor may cause application of energy at two MSEs that may result in the excitation of two field patterns 501 and 502, illustrated in FIG. 5B. Patterns 501 and 502 both related to the same mode family TE104 and TE401 are given in a way of example only. Method 500 is not limited to the excitation of any field pattern that may be excited in a particular EM energy application apparatus.

Method 500 may also include a step of weighting the selected field patterns (step 520). The weighting may be such that the sum of the field intensity distributions of the weighted field patterns equals to the target field intensity distribution, for example, to apply a first amount of energy to a first region in the energy application zone and a second amount of energy to a second region in the energy application zone 9. The first and/or second amounts may be predetermined or may be determined based on a received feedback (e.g., an EM feedback). In some embodiments, the first amount of energy may be different from the second amount of energy. The weighting may include the power at which the field pattern is excited and/or the time duration in which the field pattern is excited. For example, an equal weight of 0.5 may be given to field patterns 501 and 502.

Method 500 may also include a step of exciting the one or more selected field patterns. This excitation may be according to their weights, at step 530. The process may include, optionally, as part of excitation step 510, selecting one or more radiating elements for exciting each of the selected field intensity distributions. The selection may be based on the position of the selected (or not selected) radiating element, and in some embodiments also on the relationship between this position and the field value of the field pattern at the aforementioned position. For example when given an equal weight of 0.5 to field patterns 501 and 502, pattern 503 may be excited in the energy application zone 9.

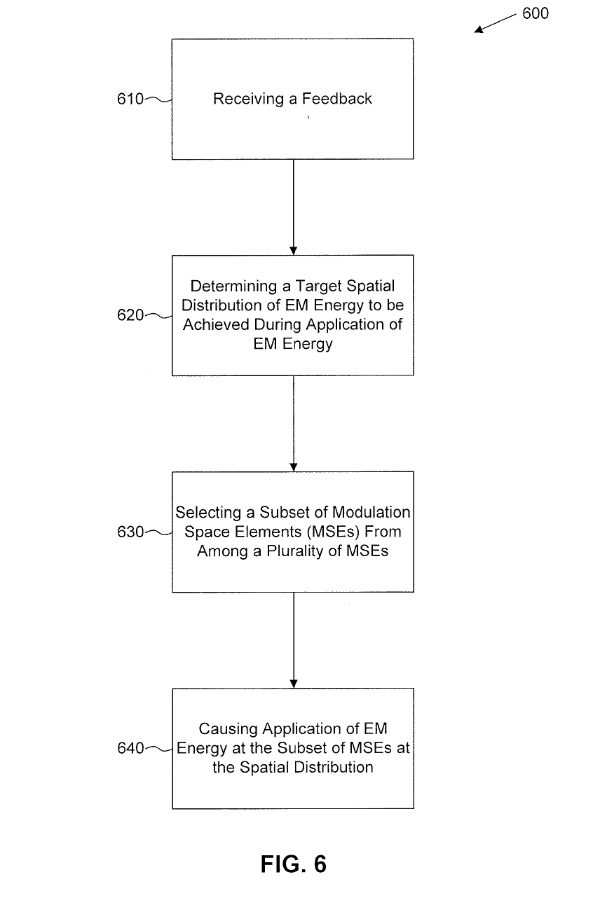

FIG. 6 is a flowchart of another method 600 of controlling aspects of EM energy application to object 11 by apparatus 100, based on feedback. Method 600 may be performed, for example, by apparatus 100 shown in FIG. 1 or FIG. 4. Steps described in FIG. 6 belonging to method 600 may be performed by or in conjunction with processor 92 and/or a processor 2030 shown in FIG. 4, for example.

As shown in FIG. 6, in some embodiments, method 600 may first include receiving feedback (step 610). Feedback received in step 610 may include any type of feedback discussed herein, including but not limited to EM feedback, for example. At step 610, any number of analytical processes may be performed on the feedback. For example, the feedback may be subject to various filters, mathematical operations and/or logical operations in order to extract useful data, including, but not limited to, examples described herein. Alternatively, the feedback may be used without processing. In some embodiments, step 610 may be conducted in similar manner to step 304 of FIG. 3, as described above.

In some embodiments, at step 620, a spatial distribution of EM energy to be achieved during application of EM energy may be determined.

In some embodiments, the spatial distribution may be determined without feedback received in step 610. For example, the spatial distribution may be determined based on known characteristics of the energy application zone 9, object 11 or other entity in the vicinity of energy application zone 9. Such known characteristics may include, for example, a dimension or property of the energy application zone 9 or object 11. For example, the object 11 may include a flame to be anchored and stabilized by application of EM energy and the known characteristics may include one or more dimensions of the combustion chamber and the turbine. The known characteristics may alternatively or additionally include a known EM energy absorption profile of the object 11 or energy application zone 9 or any other known characteristic that may be relevant to a determination of the spatial distribution. In addition or in alternative to the above, the spatial distribution may be determined based on one or more optional stored spatial distributions. For example, the processor 92 may determine a spatial distribution to use from a plurality of stored or predetermined spatial distributions. The determination of which spatial distribution to use may be based on, for example, an operation parameter of a system, device or object 11 (e.g., a combustion chamber, a flame, a turbine comprising the combustion chamber, a piston, a fuel mixture and/or a vehicle comprising the piston and/or the fuel mixture) in the energy application zone 9. The operation parameter may include, for example, an operation condition of an engine associated with a vehicle.

In some embodiments, this spatial distribution may be based on the feedback received in step 610. Determining the spatial distribution based on feedback in step 610 may include using any of the examples of known characteristics of the energy application zone 9, object 11 or other entity in the vicinity of energy application zone 9 described herein in conjunction with the feedback. For example, feedback relating to temperature of the object 11 may be used to select from among a plurality of stored spatial distributions. As another example, feedback including a temperature of loss profile of the object 11 may be used in conjunction with a known dimension or layout of the object 11 (e.g., a layout showing a location of a flame to be anchored) to determine the spatial distribution. Any number of suitable protocols for determining the spatial distribution, including those based on the received feedback may be used, including, but not limited to, examples described herein. For example, the feedback may include a temperature or loss profile (as described above) of object 11. At step 620, the processor may, in this case, determine the spatial distribution such that portions of object 11 that have relatively low temperature, as indicated in the temperature profile, receive a relatively high level of EM energy in order to heat them. In another example, the processor may determine the spatial distribution such that portions of object 11 exhibiting relatively high loss, as indicated in the loss profile, receive a relatively high level of EM energy. It is to be understood that any suitable criterion and protocol discussed herein for applying EM energy may be used in step 620 to determine the spatial distribution in step 620.

In some embodiments, method 600 may also include a step of selecting a subset of MSEs at which EM energy is to be applied to the energy application zone. The subset of MSEs may be selected based on known characteristics of apparatus 100, for example the usable bandwidth of MSEs, or know characteristics of object 11, for example frequencies which are resonant in object 11. In some embodiments, selecting two or more subsets of MSEs from a predetermined subset of MSEs may be conducted in a predetermined order (e.g., sequentially), for example a first subset of MSEs may be selected to be applied and a period of time later a second subset of MSEs may be selected to be applied. Additionally or alternatively, the selecting may be based on a feedback, for example selecting a subset of MSEs all associated with EM feedback value at each MSE higher (or lower) than a threshold. In some embodiments, the subset of MSEs may be selected to provide the target spatial distribution (step 630). The subset of MSEs may be selected from a plurality of MSEs available to apparatus 100 or that apparatus 100 is otherwise capable of providing. The plurality of MSEs may be predetermined and stored in a memory to which controller 101 (or processor 92 or 2030) has access. Alternatively, the plurality of MSEs may be determined during any of steps 610-630.

Energy may be applied to the subset of MSEs (simultaneously, sequentially, or in any desired order or groupings) such that field patterns are generated corresponding to each of the subset of MSEs for which energy is applied. A linear combination of the resulting field patterns and the energy applied via those field patterns may provide the target spatial distribution of EM energy, as discussed above. The subset may include any suitable number of MSEs for creating the patterns for providing the target spatial distribution of EM energy. In some cases, the subset may include only a single MSE. In other embodiments, the subset may include two, three, or many MSEs.

The target spatial distribution may enable energy application to selected regions of energy application zone 9 or in or on object 11. For example, the target spatial distribution may apply a first amount of energy to a first region in the energy application zone 9 and a second amount of energy to a second region in the energy application zone 9, the first and second regions corresponding to different portions of the object 11. In some embodiments, the first amount of energy may be different from the second amount of energy in order to, for example, heat different portions of the object 11 to different temperatures.

Method 600 may also include a step of causing application of EM energy at the selected subset of MSEs, optionally in order to provide the spatial distribution (step 640). Step 640 may further include determining a time duration and/or power levels for applying the EM radiation. Determining a time duration may be based on, for example, the feedback received in step 610. For example, the time duration may be set, based on the feedback, such that a certain portion of object 11 is heated to a certain temperature. Alternatively, the time duration may be based on other considerations, such as a user set time duration, for example. The application may include, optionally, selecting one or more radiating elements for exciting each of the MSEs in the subset. The selection may be based on the position of the selected (or not selected) radiating element, and in some embodiments also on the relationship between this position and a field value of the MSE at the aforementioned position.

It is to be understood that, although FIG. 6 shows a single iteration of method 600, the method may be performed any suitable number of iterations. For example, method 600 may be performed in an iterative fashion in order to update the application of EM energy (step 640) according for example to changes in feedback received in step 610. In some embodiments, method 600 may be iteratively performed according to a criterion with respect to the feedback. For example, method 600 may be performed until a certain portion of object 11 is heated to a certain temperature. Additionally or alternatively, method 600 may be iteratively performed for a fixed or set number of iterations or for a fixed time period.

When method 600 is performed iteratively, a timing of the iterations may also be set and/or changed. The timing of the iterations may be set and/or changed in any of steps 610-640. The timing of the iterations may be set according to a particular goal with respect to EM energy application. The goal may or may not be defined in terms of the feedback collected in step 610. For example, the timing of the iterations may be set such that iterative applications of EM energy in step 640 are performed with sufficient rate to maintain a portion of object 11 at a particular temperature, as measured by a feedback temperature profile received in step 610. Alternatively, or in addition, the timing of iterations may be set such that iterative applications of EM energy in step 640 do not exceed a threshold associated with a known materials parameters of the object 11. For example, the timing may be set such that successive iterations do not reach an EM energy/power threshold above which portions of the object 11 may lose structural integrity.

Some or all of the forgoing functions and control schemes, as well as additional functions and control schemes, may be carried out, by way of example, using structures such as the EM energy apparatus schematically depicted in FIG. 1 or FIG. 4. Within the scope of the invention, alternative structures might be used for accomplishing the functions described herein, as would be understood by a person of ordinary skill in the art, reading this disclosure.

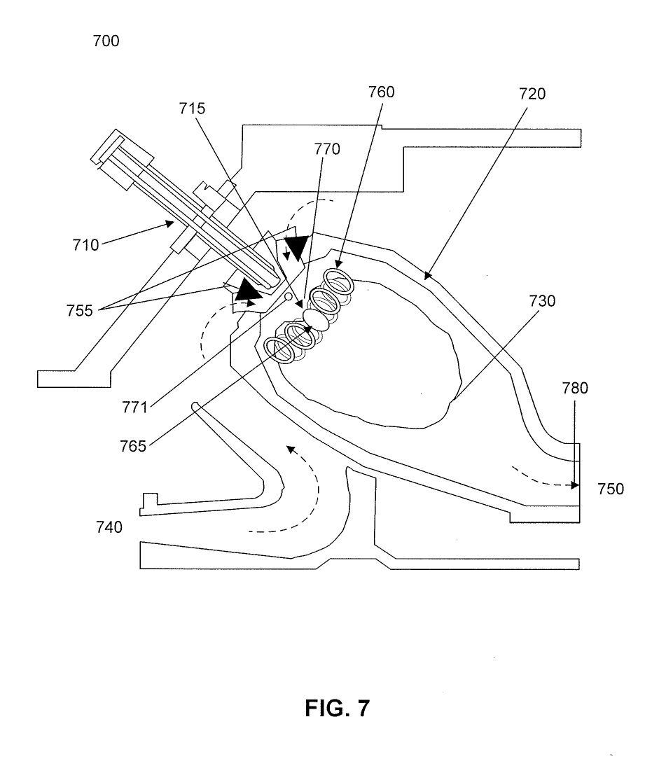

An apparatus 700 for anchoring a flame in a turbine (e.g., in the combustion chamber in the turbine) is illustrated in FIG. 7, in accordance with some embodiments of the invention. The flame in the turbine may be ignited in burner 710. Burner 710 may create flame 715 by burning the same gas (fuel) that may power the turbine or may use additional fuels such as oil. The gas and/or the additional fuels may be mixed in combustion chamber 720 with oxidizing atmosphere (e.g., air) to burn the fuel. Burner 710 may be located at least partially inside combustion chamber 720 in a turbine, optionally at the entrance of combustion chamber 720. Chamber 720 may include entrance 740 for compressed oxidizer (e.g., air) from a compressor. The compressed oxidizer may mix in the chamber with fuel (e.g., natural gas or oil) to feed flame 715. Flame 715 may combust the fuel and the compressed air, thus increasing the pressure of the combustion products. Combustion chamber 720 may further include an outlet 750 for introducing the combustion products to the turbine, to power the turbine.

In some embodiments, flame 715 may be anchored in the chamber 720 such that flame 715 may be outside of burner 710 and not in the burner (e.g., to avoid overheating of the burner). In addition, flame front 730 may not be ahead of combustion chamber 720, to avoid blowout of the flame to the turbine. Flame front 730 may not reach point 780, and may not exit from combustion chamber 720 via outlet 750. Flame 715 may be anchored at burner exit 770 throughout the operation of the turbine, for example by flame anchoring element 771. Flame 715 may be anchored closely to burner exit 770, in order to ensure stable combustion within a wide operation window. The operation window or different operation regimes may include using, different types of fuels, and variations in flame temperature, velocity and location. Some gas turbines are designed as dual fuel turbines, and constructed to burn at least two different type of fuel: e.g., gas and fuel oil. In some embodiments, burner 710 may be designed such that flame 715 is stabilized and anchored in any operation regimes included in a dual fuel turbine.

In some embodiments, a wide operation window for the turbine may include the ability to operate the turbine using different fuel mixture ratios. For example, the fuel mixture may be a stoichiometric mixture (e.g., 14.7:1 for gasoline mixture) or below stoichiometric ratio mixture also known as “reach mixtures”. The mixtures above stoichiometric ratio mixture also known as “lean mixtures” and may, for example, have 30:1 or 50:1 or 60:1 or 100:1 or even 200:1 air/fuel ratios. The leaner the fuel mixture, it may be harder to stabilize and anchor the flame. In some embodiments, combustion reaction in lean fuel mixture may occur at relatively low temperature (e.g., at 1300K, 1400K, 1500K, 1600K), which may decrease formation of NOₓ which may result in a decreased pollution level. In some embodiments, for ultra lean mixture, the combustion speed may be slower than that of stoichiometric mixtures.

In some embodiments, combustion chamber 720 may include at least one radiating element 755 which may be configured to apply EM energy (e.g., EM energy in the RF range) via at least one MSE to flame 715, such that EM energy may be applied to anchor the flame to a desired position at the burner exit, while avoiding flame penetration to the main turbine flow or blowout. In some embodiments, more than one radiating element 755 (e.g., elements 755 illustrated in FIG. 7) or an array of elements 755 may be installed in chamber 720. Optionally, radiating element(s) 755 may be installed outside of chamber 720 and the EM energy may be applied through a window in chamber 720 (not illustrated), wherein the window may be made from a material at least partially transparent to EM energy, optionally in RF range. RF transparent window may be constructed from any dielectric material capable of transferring at least a portion of the RF energy emitted from element 755.

In some embodiments, EM energy may be applied to flame 715 in the turbine. A flame may any number of zones, for example, the following three zones: a plasma zone, lower ionic content zone and diffusive zone. The plasma zone may include higher content of ions from the fuel and the oxidizer in an ionic state, thus may interact with an EM field that may be applied to the zone. A spatial distribution of EM energy may be determined, for example according to methods 500 and 600 and FIGS. 5 and 6, such that EM energy may be applied to the plasma zone in flame 715. For example, EM energy may be applied to at least one of areas 760, or to all of areas 760 at once, for example by selecting at least a subset of MSEs from a plurality of MSEs that may result in a field pattern that may have high intensity areas that are at least partially overlapping with area(s) 760. In some embodiments, a sequential application of EM energy may be conducted. For example, a first amount of EM energy at a first set of MSEs (or a first MSE) may be applied such that a field pattern may be excited in the combustion chamber to have at least one intensity maxima overlapping with area 765. A period of time later, a second amount of EM energy at a second set of MSEs (or a second MSE) may be applied to other 760 area, optionally neighboring to area 765. A processor may control the timing of the first and second EM energy applications, such that flame front 730 may be anchored throughout the working period of the turbine, with or without flame anchoring element 771.

In order to anchor the flame it may be required to locally increase the temperature of the plasma zone in the flame, for example increase by 50° C., 70° C. or 100° C. The increase in temperature may result in a favorable area for combustion, thus may anchor the plasma zone of the flame to this area. EM energy that may be applied to the favorable area, for example by determining a spatial EM energy distribution that may cause an increase of the plasma temperature in the flame. In some embodiments, the amount or amounts of EM energy that may be applied to the flame may be determined based on several aspects related to the turbine operation and/or the EM source that supply the EM energy to radiating elements 755. The amount of EM energy may be determined based on the type and properties of the fuel used to power the turbine and create the flame (e.g., type of fuel, fuel mixture). For example, the turbine may be operated by gas or oil, and the flame may include ions of either gas, oil or both. In addition, the ratio between the fuel and the oxidizer may further influence the characteristics of the ions and plasma zone in the flame. The higher the concentration of ions (e.g., due to close to stoichiometric ratio between the air and the fuel) the lower the amount of EM energy that may be needed to anchor the plasma zone of the flame. Other operational parameters of the turbine may be a pressure from the compressor and the amount of fuel flow mass, that has to be combusted.

In some exemplary embodiments, the energy needed to increase the temperature of the plasma zone in a flame in about 100° C., may be estimated using the following calculation. The power needed to increase the flame temperature by 100° C. is proportional to the volume ratio between the LED (Local Energy Application, e.g., area 765 illustrated in FIG. 7) working zone to entire flame plasma zone:

Pn=Vratio·(m/t)·Cp·ΔT=Vratio·0.41·1.2·100=0.5−2.5 kW

wherein Vratio is the volume ratio range equal to 0.05−0.01 (VLED/V). Pn is equal to the power loss from collision between RF energy excited plasma electrons and feed molecules and equal to power gain by the electrons from the EM field, other constants and parameters are listed below:

Pn=Pe=0.5·e2·E2·ne·VLED/(me·νe)

The above equation may extract the time average electric field E needed for the necessary power. The electric field strength may dependent on the EM apparatus for applying EM energy, optionally in the RF range designed to stabilize the flame. For example, if an open ended WG (WR430) is chosen as a radiation element 755:

Ptot=a·b·E2·(1−fc2/f2)0.5/(4·η)=1.7−8.5 kW

While a and b are the WG cross-section dimensions 0.109m and 0.0546 m respectively, fc is the cutoff frequency 1.373 GHz, η—is the impedance of the free space 377Ω, and wherein:

Pn—Power needed for temperature increment of the flame's neutral molecules [W].
Pe—Power gain from RF/MW energy of the flame's plasma electrons [W].
m/t—fuel mass flow per burner 0.41 kg/sec.
Cp—Flame specific heat 1.2 kJ/kg/K
ΔT—Flame temperatures difference 100° C. (estimation).
V—Flame plasma typical volume 0.01 m³ (10 liter).
VLED—LED volume range from 0.0001-0.0005 m³ (0.5-0.1 liter).
Ptot—Total transmitter power needed [W].
f—Transmitted frequency 2.4 [GHz].
ne—Plasma electron density 1019 [m⁻³].
νe—Electron-Neutral molecules collisions frequency 1011 [Hz].

Ptot may have a wide range depending on various aspects of the fuel and the energy application apparatus (e.g., power source, radiating elements etc.).

In some embodiments, combustion chamber 720 may include a flame anchoring element 771 which may be located in an exit of burner 710, optionally near the plasma zone of flame 715. EM energy may be applied to heat the flame anchoring element 771 to create a preferred location for heating the plasma zone of the flame. The anchoring element 771 may be constructed from any material capable of resisting the high temperatures that exist in the burner, for example temperatures above 1200° C., or above 1300° C., or above 1500° C. or above 1600° C. For example, various steels, Ni based alloys, alloys and metals with high melting temperatures, various ceramic (e.g., oxides, carbides, nitrides etc.) and composites of one or more of the above materials may be used. The anchoring element 771 may have any shape that has a high surface to volume ratio, and may allow the fuel mixture and the combustion products to flow through the anchoring element without major interruption of gas flow. Fuel oxidation may occur in a preferred site, for example on the surface or places with slightly higher temperature (e.g., +100° C.) than the surrounding environment. Thus, elements 771 with high surface to volume ratio may allow oxidation reactions (e.g., burning) to take place simultaneously. The anchoring element 771 may comprise a porous material, for example, a material having a surface to volume ratio of: 50, 100, 200, 300 or 400. The anchoring element 771 may have a defined porous shape, for example, honeycomb shape or an arbitrary porous shape. The anchoring element 771 may comprise an EM absorptive material that may absorb the EM energy emitted from the radiating element(s). For example, the anchoring element 771 may comprise SiC particles or may be made completely from SiC. The anchoring element 771 may comprise small metallic particles in a non metallic matrix or any other structure designed to absorbed EM energy, for example in the RF range. Optionally, the anchoring element 771 may comprise a catalyzer, e.g., catalytic converter with catalytic material and/or particles designed to accelerate and encourage oxidation reactions at lower temperatures, e.g., 1200° C. or 1300° C. in gas turbines, thus by applying EM energy to the catalyzer, the catalytic oxidation reaction may be accelerated. The anchoring element 771 may comprise catalytic particles for example: Pd, Pt, Pt—Rd, K₂O and/or MoCo. The catalytic particles may be metallic particles (e.g., Pd, Pt, Pt—Rd) which absorb well EM energy.

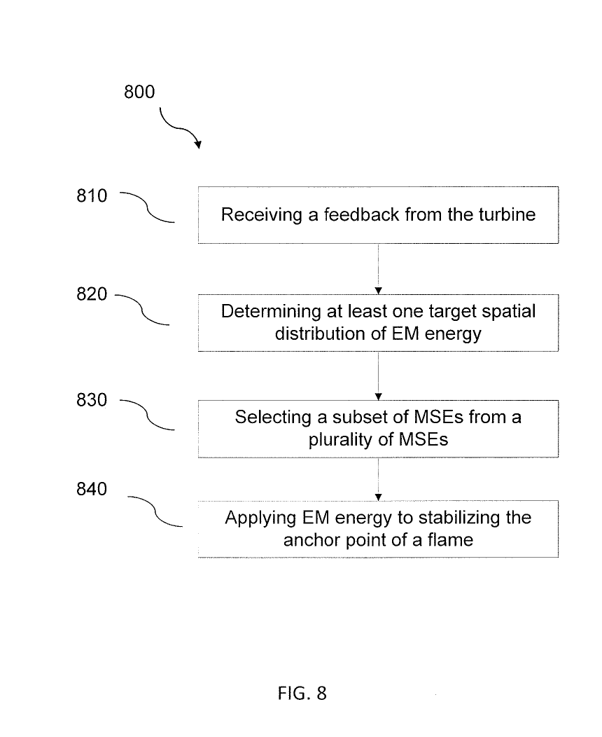

A method for applying EM energy, optionally in the RF range, in accordance with some embodiments of the invention, is presented in FIG. 8. Method 800 may be conducted by a processor (e.g., processor 92 or processor 2030). Processor 92 may be configured to receive a feedback (from the turbine) relating to at least one aspect of the flame or to other operational aspects of the turbine, in step 810. The feedback may include information relating to: temperature of the flame, a flow of gasses in the combustion chamber, a pressure of the compressed air, a location of the flame, a flame intensity (e.g., size, volume, and/or amount of light the flame emits and a shape of the flame), whether the flame oscillates (e.g., whether there are combustion oscillations), a chemical composition the fuel mixture etc. The processor may receive feedbacks from one or more sensors, for example: a thermometer (e.g., a pyrometer) may measure the temperature of the flame, a flow meter may measure the flow of gasses in the combustion chamber, a pressure gage may detect the pressure of the compressed air, a visual light camera may detect a location of the flame in the burner). In addition, piezoelectric sensors may detect vibrations of the turbine and/or the combustions chamber (whether there are combustion oscillations). Optionally, the gases emitted from the turbine may be detected, for example the amount of NOₓ may be monitored. In some embodiments, the feedback may include more than one feedback, for example the temperature and the location of the flame. In some embodiments, the feedback may be an EM feedback according to some embodiments of the invention. In some embodiments, the EM feedback may be detected by the one or more radiating elements (e.g., elements 755). The EM feedback may monitor EM aspects of the flame that may be related for example to the ions in the flames plasma. In some embodiments, the EM feedback may be indicative of the EM energy absorbable in the flame (e.g., the plasma zone in the flame) or the fuel mixture. Additionally or alternatively, the feedback may be a sound wave. The processor may adjust the EM energy application to the flame according to the feedback. For example, the processor may determine an amount of energy or power to be applied to the flame based on at least one feedback (e.g., the flow rate, the amount of NOₓ in the emitted gasses, value indicative of EM energy absorbable in the flame or the fuel mixture etc.)

In some embodiments the processor may determine a spatial EM energy distribution to be achieved during the application of the EM energy, in step 820. The spatial distribution may be determined based on the structure of the burner and the combustion chamber; such that the flame (e.g., flame 715) may be anchored in a predetermined place. Additionally or alternatively, the spatial EM energy distribution may be determined based on one or more feedbacks related to at least one aspect of the flame, for example at least one of the feedbacks received in step 810. The processor may determine the spatial distribution based on the location of the flame, the size of the flame, the amount of combustion oscillations, etc. The processor may determine the spatial energy distribution based on an EM feedback related to the flame or the fuel mixture. For example, the EM feedback may be indicative of the amount of EM energy (e.g., in the RF range) that is absorbed by the plasma zone in the flame or in another zone. The larger and/or denser the plasma zone (i.e., the larger is the amount of ions in the zone) the larger the EM energy absorption of the flame.

In some embodiments, the processor may be configured to select a subset of MSEs among a plurality of MSEs at which EM energy from the at least one radiating element (e.g., element 755) can be applied to the flame, in step 830. The processor may select the subset of MSEs, or at least one MSE based on predetermined calculations or computer simulations, such as computer simulations that take into accounts the structure of the turbine and the structure of the EM energy application apparatus installed in the combustion chamber. The processor may be configured to select the subset of MSEs such that the selected subset of MSEs, selected, for example, to provide at least one spatial distribution of EM energy, for example the spatial distribution determined in step 820. Additionally or alternatively the processor may select the subset of MSEs based on one or more feedback related to at least one aspect of the flame or the turbine, for example, feedback regarding the location of the flame in the burner (e.g., a photo of the flame or loss profile of the fuel mixture during burning).

In some embodiments, EM energy (e.g., in the RF range) may be applied to the flame to stabilize the anchor point of the flame, in step 840. The EM energy may be controlled based on one or more of steps 810-830. In some embodiments, the duration at which EM energy is applied at one or more MSEs may be controlled. In some embodiments, the power at which EM energy is applied at one or more MSEs may be controlled. In some embodiments, the spatial EM energy distribution may be determined and the processor may be configured to cause the application of the spatial energy distribution to the flame. Additionally, the processor may determine the spatial energy distribution based on a feedback related to at least one aspect of the flame or the turbine. The processor may further select a subset of MSEs among a plurality of MSEs such that the spatial distribution may be provided. Alternatively, the processor may select a subset of MSEs from a plurality of MSEs and cause the application of EM energy to the flame at the selected MSEs. The processor may further be configured to select the subset of MSEs based on a feedback related to at least one aspect of the flame. In some other embodiments, the processor may control the application of EM energy to the flame based on a feedback. For example, the processor may determine an amount of EM energy to be applied to the flame based on a feedback related to the temperature of the flame. The processor may further be configured to determine the duration at which energy (e.g., power) is applied to the flame. The processor may determine the duration of EM energy application at each MSE in the selected set, such that, upon the application of the entire MSEs in the selected set, the determined spatial distribution may be achieved. The process of determining time duration for the application of energy at a particular MSE is related to the process of weighting MSEs discussed above.

In some embodiments, steps 810-840 may be repeated several times during the operation of the turbine, and the processor may be configured to determine the timing of the EM energy applications. For example, EM energy may be applied every determined amount of time (e.g., every 5 sec, 1 min, 5 min, 10 min) or based on the feedback received from the turbine. The determining of spatial distribution and/or MSE selection may be repeated each time a change is detected in the feedback, for example: in conjunction with or related to changes in the location of the flame, changes in the intensity of the flame, if combustion oscillation starts in the flame, changes in temperature of the flame, changes in the amount and/or composition of the gases emitted from the turbine, or changes in the loss profile of the fuel mixture.

Computer simulation of applying EM energy at a frequency of 2.45 MHz, using 3 radiating elements, is presented in FIG. 9. In the simulation, three radiating elements were emitting EM energy having phase differences between them. For example the MSEs may include 2.45 MHz, and 90 degrees and −90 degrees between the radiating elements. FIG. 9 is an EM field intensity map showing the EM field intensities in a cross section of a flame near the anchoring point in a turbine. The simulation was based on the calculations and data showed above. The simulation result in high field intensity area (910) in the middle section of the flame (e.g., near the exit of the burner). This area is expected to absorb an amount of EM energy that will be sufficient to increase the temperature of the plasma zone in the flame in approximately 100° C., thus anchoring the flame to the exit of the burner.

Some embodiments may involve applying EM energy in combustion processes either in internal or external combustion engines, for example, in order to ignite a fuel mixture inside a combustion chamber. The combustion engine may be installed in a vehicle (e.g., a passenger car, a truck, an autobus, a train or an airplane) or may be installed inside a power plant, generator, etc. The EM energy may be applied to the fuel mixture to obtain ignition. The fuel mixture may include a mixture of a fuel and an oxidizer (e.g., oxygen or air). The fuel may be any material configured to store chemical energy that can later be extracted by processes such as oxidation to perform mechanical work. Some examples of fuels are: fossil fuels containing hydrocarbons originating from liquid petroleum (e.g., gasoline, diesel, kerosene, jet fuel, liquefied petroleum gas and/or ethane), natural gas (e.g., methane and/or ethane), or biofuels (e.g., bioethanol, biodiesel, green diesel, vegetable oil, bioethers, biogas or syngas). An oxidizer (also referred to as “oxidant”) may be any chemical compound, or a mixture containing a chemical compound, that readily transfers oxygen atoms (e.g., air, oxygen, nitromethane, nitrous oxide and/or hydrogen peroxide). When exposed to EM energy, the temperature of the fuel and/or the fuel mixture may increase until a combustion (also known as “burning”) reaction is ignited. Upon ignition of the combustion reaction, the fuel and oxidizer may react to produce gas at high-temperatures and, thereby, increase pressure. A combustion process preformed in a combustion chamber (e.g., a cylinder or a turbine) may utilize the gases to apply force to component(s) in a combustion engines (e.g., pistons, turbine blades or a nozzles).

To ignite a fuel mixture, the temperature of the mixture should reach at least a minimum temperature (i.e., an “ignition temperature”) that ensures rapid ignition of the fuel at a certain pressure. The ignition temperature may be the lowest temperature at which the fuel mixture ignites and in which the combustion reaction may occur in a substantially short reaction rate. Some examples of ignition temperatures of common fuel are: 700° C. (gasoline) and 1200° C. (diesel). Ignition may also be performed using a spark to ionize and/or locally heat the fuel mixture and ignite the combustion reaction (e.g., in a gasoline engine). The term “gasoline engine” may refer to an engine that is operated by gasoline fuel. EM energy may be applied to the fuel mixture in a gasoline engine to either elevate the temperature of the fuel mixture and/or to ionize the fuel mixture. The fuel mixture may be ionized by the EM energy application or by a spark created by the EM energy application.

In some embodiments, EM energy may be applied to ignite a fuel mixture in a combustion chamber. The fuel mixture may be mixed prior to its injection into the combustion chamber (e.g., gasoline-air mixture is injected to the combustion chamber) or created by spraying or injecting a fuel and air into a combustion chamber (e.g., diesel fuel injection). The fuel mixture may have several air/fuel ratios, which may be defined as, (the mass of air)/(the mass of fuel). For example, the fuel mixture may be a stoichiometric mixture (e.g., 14.7:1 for gasoline mixture) or a below stoichiometric ratio mixture (e.g., 12.5-13:1 for gasoline mixture) commonly known as a “reach mixture”. The mixture may be above a stoichiometric ratio mixture also known as “lean mixtures” and may, for example, have 30:1 or 50:1 or 60:1 or 100:1 or even 200:1 air/fuel ratios. Different air/fuel ratios may require different EM energy application schemes. For example, igniting reach mixtures may, for example, require less power applied for a shorter time than ignition of lean or very lean fuel mixtures. In some embodiments, a combustion reaction in lean fuel mixture may occur at relatively low temperature (e.g., at 1300K, 1400K, 1500K, 1600K), which may decrease formation of NOₓ. NOₓ is considered a significant pollutant in combustion reactions. In some embodiments, a combustion reaction in a lean fuel mixture may occur at relatively low temperature, which may result in a decreased pollution level. In some embodiments, for an ultra lean mixture, the combustion speed may be slower than that of stoichiometric mixtures. In some other embodiments, multiple ignitions may be obtained by EM application so that the travel distance of the combustion waves may be shorter, thus the time needed to perform a complete combustion may be shorter, which may result in a higher engine speed.

In some embodiments, EM energy may be applied to ignite a fuel mixture in a combustion chamber. At least one spatial distribution of EM energy may be determined. The spatial distribution may be determined according to any known method, for example methods 500 and 600 as disclosed in respect to FIGS. 500 and 600. In some embodiments, determining the at least one target spatial distribution of EM energy further comprises determining an amount of EM energy to be absorbed by the fuel mixture in at least a portion of a volume in a combustion chamber.

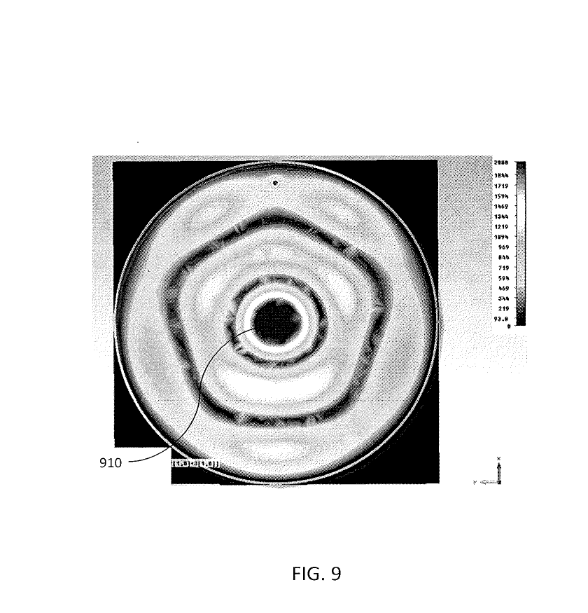

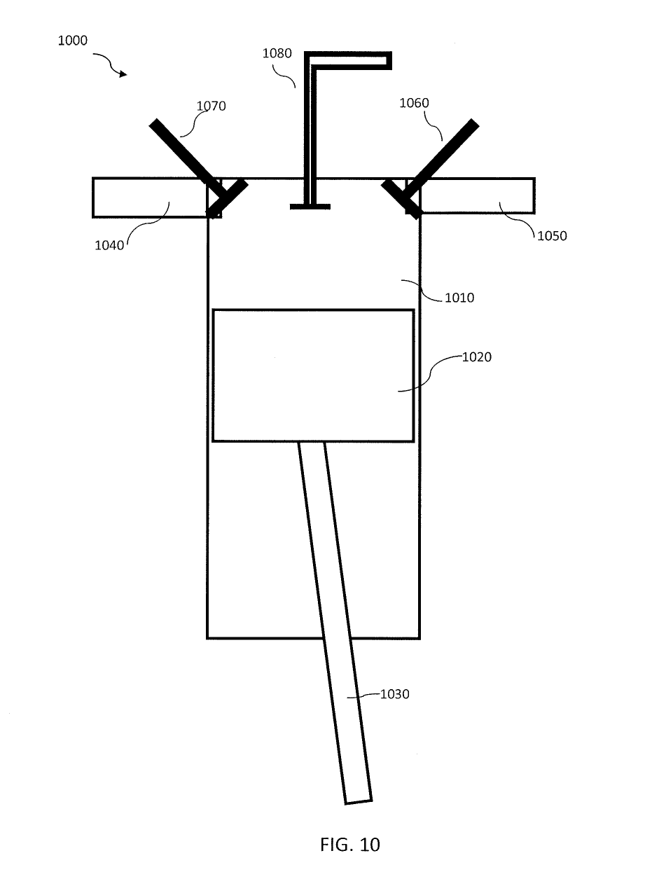

In some embodiments, EM energy application may be controlled based on a feedback for example: received from the fuel mixture, the combustion chamber or from an engine comprising the combustion chamber. In some embodiments, the spatial distribution may be determined based on a feedback. The feedback may be related to at least one aspect of the fuel mixture and/or at least one aspect of the combustion chamber and/or at least one aspect related to an engine comprising the combustion chamber. For example, the feedback may be related to at least one of a temperature of a fuel mixture in a chamber, a temperature of a portion of the chamber, geometry of the chamber, a relative position of an engine component (e.g., a piston), or a composition of the fuel mixture in the chamber. The feedback may be received from a sensor (e.g., sensor 20) place in the combustion chamber, in an engine comprising the combustion chamber or a vehicle comprising the engine. The sensor may include a thermometer, a pressure gage, a piezoelectric gage configured to measure movements or vibrations, etc. In some exemplary embodiments, a processor (e.g., processor 92) may receive information regarding the position of a piston in a cylinder (e.g., piston 1020 in cylinder 1000, illustrated in FIG. 10) and determine a spatial EM distribution such that EM energy may be applied to one or more portions inside the cylinder. For example, EM energy may be applied to the space between the piston and the cylinder. Optionally, EM energy may be spatially applied to the upper face of the piston, such that the ignition may create a combustion front on the upper face of piston, to gain maximum expansion energy from the combustion. In yet another example, the amount of EM energy to be applied to the fuel mixture may be determined based on the temperature of the combustion chamber, such that for example a higher amount of EM energy may be applied when the temperature of the combustion chamber is low (e.g., at cold start). The feedback may include EM feedback, optionally associated with a plurality of MSEs. For example, the EM feedback may be indicative of the ability of the fuel mixture to absorb EM energy. The processor may be configured to control the application of the EM such that the determined spatial energy distribution may be achieved.

Different mixtures (e.g., of various ratios) of different fuels and different oxidizers may have different abilities to absorb EM energy. For example, lean fuel mixtures may have lower absorption ability than reach mixtures, optionally requiring higher EM energy application in order to ignite. Generally, the higher are the amounts of fuel and/or oxidizer atoms in the combustion chamber—the higher is the ability of the fuel mixture to absorb EM energy. After combustion, the products of the combustion reaction may have different ability to absorb EM energy than the fuel mixture. Thus EM feedback received from the combustion chamber may indicate if the chamber contains fuel mixture to be ignited, combustion products to be exhaust, or other gases prior to the injection of the fuel or the fuel mixture. The processor may be configured to determine the amount of EM energy to be applied to the fuel mixture based on the received EM feedback, according to any known method, for example according to method 300 disclosed in respect to FIG. 3

In some embodiments, EM energy application timing may be controlled based on the feedback. For example, EM energy may be applied based on the rotational speed of the engine or the position of the piston. Alternatively, the timing may be controlled based on EM feedback indicative of the EM energy absorbable in the fuel mixture. In some embodiments, EM energy application may be adjusted several times during the operation of the combustion engine and the feedback may be received periodically (e.g., during every combustion cycle, several times within a combustion cycle and/or every several combustion cycles). EM energy application may be adjusted in response to changes in the fuel mixture during different operation regime (e.g., during multi-regime operation) of the engine (e.g., cold start, cruising or acceleration). Additionally or alternatively, the EM energy application may be controlled based on parameters related to the fuel mixture and the combustion chamber for example: the air/fuel ratio, the fuel type and/or measurements of the EM energy absorbable in a particular fuel mixture done prior to the injection, optionally in an energy application zone other than the particular cylinder (e.g., during laboratory tests of various fuel mixtures).

Some embodiments for applying EM energy in combustion processes, for example, in order to ignite a fuel mixture inside a combustion chamber, may include selecting a subset of MSEs from among a plurality of MSEs. A processor (e.g., processor 92 or processor 2030) may select the subset of MSEs based of a feedback (e.g., EM feedback). For example, an EM feedback may MSE dependent, such that each value of the EM feedback may be associated with a particular MSE and the processor may be configured to select the subset of MSEs based on an MSE dependent EM feedback. For example, the processor may be configured to select the subset of MSEs based on EM feedback related to the EM energy absorbability in the fuel mixture, e.g., by selecting MSEs associated with EM feedback having a value higher (or lower) than a threshold. In some embodiments, the subset of MSEs being selected to provide the spatial distribution of EM energy. The processor may select the subset of MSEs such that an EM field pattern may be excited in the combustion chamber that will at least partially overlap with determined spatial energy distribution. The processor may cause the application of the EM energy at the selected subset of MSEs.

In some embodiments, a first EM energy profile (EM energy spatial distribution) may be determined (selected) such that EM energy may be selectively applied to the fuel mixture in a first portion of a combustion chamber, for example to the upper portion of the chamber when the piston is in a high position (e.g., the highest possible position), to initiate ignition. Then a second spatial EM energy profile may be determined such that EM energy may be selectively applied to the fuel mixture in a second portion of the combustion chamber, for example as the piston moves downwards the second spatial EM energy profile is applied to the middle section of the chamber to ensure complete combustion of the fuel mixture. A processor (e.g., processor 92 or processor 2030) may be configured to control the timing of causing application of the EM energy (e.g., at one or more spatial profiles), for example, based on a relative position of a piston in a cylinder. The EM energy application may be controlled such that the first spatial EM energy profile is configured to cause absorption of EM energy during a first time period, and the second spatial EM energy profile is configured to cause EM energy absorption during a second time period. Optionally, at least a portion of the second time period does not overlap with the first time period. Since EM energy application in the RF range may be controlled on timescales of the order of nanoseconds or microseconds or milliseconds, the timing of the ignition may be very accurately controlled. A processor (e.g., processor 92 or processor 2030) may be configured to apply the first spatial EM energy profile to the combustion chamber in a suitable moment or timing for combustion, which may facilitate obtaining a more efficient or optimally efficient combustion. For example, the controller may be configured to apply the first spatial EM energy profile when a piston reaches a highest point in a cylinder. The timing control may be based on a feedback, for example, on piston movement, the amount of residual exhaust gas(s) after the combustion, an engine load, the torque of the engine and/or the engine efficiency, among other things. Optionally, the second spatial EM energy profile may be applied after ignition of a newly injected fuel mixture. The second spatial EM energy profile may ignite residual fuel mixture that was not ignited in the initial ignition (e.g., during application of the first spatial EM energy profile) to ensure substantially complete combustion of the fuel mixture such that CO emission levels may be below the standard regulation. Alternatively or additionally, the second spatial EM energy profile may be applied in response to a feedback, for example the movement of the piston during the piston's stroke. The spatial EM energy profiles may follow the piston (e.g., may follow the path of the piston) causing additional combustions of residual fuel mixture which may result in maximum energy efficiency extraction from the fuel mixture.

In some embodiments, the ignition may occur in accordance with one or more ignition states associated with engine operation, for example, fuel consumption and engine operation regimes during multi-regime operation. Ignitions states may be related to a cold start, acceleration or cruising regime. In some exemplary embodiments, EM energy application may be controlled, during cold start of the engine and/or during a cruising regime, such that minimal or decreased fuel consumption is used, in comparison to a conventional ignition (i.e., conventional engine with spark plug ignition). During acceleration, the EM energy application may be controlled such that the engine may produce maximal or increased torque. For example, EM energy may be controlled by determining a spatial energy distribution and/or by selecting a subset of MSEs.

In some embodiments, the EM energy may be controlled to ignite the fuel mixture in a sub threshold compression condition, allowing the fuel mixture to ignite even when the pressure and compression in the combustion chamber (e.g., diesel cylinder) has not reached a threshold compression.

In some embodiments, EM energy may be applied to aid evaporation of biofuels (e.g., bioethanol, biodiesel, green diesel or vegetable oil). Biofuels may have limited vapor pressure and may be difficult to evaporate. EM energy may be applied to heat the biofuels, for example, prior to spraying and injecting the biofuels into the combustion chamber. This process may, for example, aid the evaporation.

In some embodiments (e.g., in gasoline engines), the EM energy application may be controlled to decrease or even eliminate early ignition thereby minimizing or decreasing a need for fuels containing anti-knock agents for example organometalic and/or aromatics hydrocarbons agents. Anti-knock agents include gasoline additives used to reduce engine knocking and increase the fuel octane rating. Gasoline, when used in high compression internal combustion engines, may ignite early (pre-ignition or detonation). Precise ignition timing by accurate EM energy application may reduce or eliminate the use of anti-knock agents which are often hazardous compounds. Optionally, EM energy application may reduce or even eliminate the use of low-boiling VOCs (Volatile Organic Compounds) starting fluids. Starting fluids are, for example, a mixture of volatile hydrocarbons (e.g., heptane, butane or propane), diethyl ether, and/or carbon dioxide, the latter sometimes used as a propellant. VOCs are undesired for a number of reasons, including that they are considered hazardous to health.

In some embodiments, EM energy application may be controlled to allow a cold start of diesel engine, sub-threshold compression or the use of lean fuel mixtures of gasoline and diesel fuels (e.g., by applying EM energy to the fuel in order to ignite the fuel and/or to heat the fuel prior to ignition which may assist the spontaneous ignition of the diesel fuel). Optionally, EM energy application may reduce or even eliminate the use of low-boiling VOCs (Volatile Organic Compounds) starting fluids. Starting fluids are, for example, a mixture of volatile hydrocarbons (e.g., heptane, butane or propane), diethyl ether, and/or carbon dioxide, the latter sometimes used as a propellant. VOCs are undesired for a number of reasons, including that they are considered hazardous to health.

In some embodiments, application of EM energy to ignite or to assist the ignition of the fuel or the fuel mixture may result in reduced pollution emission to the atmosphere compared to conventional ignition methods (e.g., spark ignition). In some embodiments, the reduced pollution level may be achieved due to a reduction or elimination of the use of hazardous undesired compounds. In some embodiments, the EM energy application may be controlled or adjusted in order to obtain a desired pollution level.

Controlled EM energy application to fuel mixtures may reduce or even eliminate the need to add octane increasing additives. These compounds are usually more volatile than the fuel, thus may concentrate at a top part of an engine piston or in other places in the combustion chamber. Octane ratings measure a fuel's tendency to burn in a controlled manner, as opposed to exploding, igniting or burning in an uncontrolled manner. Where the octane rating is raised by adding compounds such as ethanol to the fuel or fuel mixture, energy content per volume is reduced. Controlling the EM energy application (e.g., by adjusting the timing, duration, power or spatial distribution of EM energy application to the fuel or fuel mixture during ignition based on a feedback, for example based on the EM energy absorbable characteristics of the fuel mixture (e.g., by detecting an EM feedback), may facilitate controlling aspects of the ignition, for example by applying the required amount of energy (power and time) as a function of the fuel mixture temperature and/or pressure. The temperature and/or pressure of the fuel mixture may be measured by a temperature measurement device (e.g., thermocouple) and/or pressure measurement device (e.g., piezoelectric sensor). Additionally or alternatively, the temperature and/or pressure may affect the ability of the fuel mixture to absorb EM energy (e.g., may change a value indicative of EM energy absorbable), thus the EM energy application may be altered in response to changes in temperature and/or pressure of the fuel mixture. In addition the processor may be configured to determine or receive an EM feedback from a combustion chamber containing combustion products (e.g., CO, CO₂ and/or water) thus any change in the combustion efficiency (e.g., that may change the composition of the combustion products), may be detected from variations in the EM feedback received from the combustion chamber containing the combustion products.

In some embodiments, the fuel mixture may include ignition catalysts (e.g., homogeneous and heterogeneous catalysts). Homogeneous catalysts include molecular compounds that may lower the activation energy of oxidation in the formation of atomic oxygen radicals. EM energy application may accelerate ignition in the presence of homogeneous catalysts, for example, in lean fuel mixtures. In some embodiments, heterogeneous catalysts may be added to the fuel as, for example, small catalytic particles. Those particles (including: Pd, Pt, Pt—Rd, K₂O, MoCo, for example) may have increased EM energy absorption characteristics than the fuel and, thus, may heat faster than the fuel. For this reason, the particles may accelerate the ignition due to a combined effect of EM energy heating and surface oxidation activation.

Some fuel mixtures (combustible fuel compounds—for example: gasoline, diesel) may include or may be mixed with EM energy absorbing material (e.g., artificial dielectrics). The EM energy absorbing material may be selected to enhance EM energy absorption by the fuel mixture, e.g., to increase or to assist the amount EM energy absorbed in the fuel which may accelerate the heating of the fuel. An exemplary potential EM energy absorbing material is graphite powder. Graphite powder is consider a good EM absorber especially in the RF range, and, if inserted in the form of fine particles (e.g., particles of less than 1 mm, or less than 1 μm or less than 100 nm) in small amounts (e.g., less than 10 wt. % or less than 1 wt. % or less than 0.5 wt. % or less than 0.05 wt. %), may heat the surrounding of the fuel mixture to reach the ignition conditions (e.g., auto-ignition temperature and/or ionization). During combustion, the graphite particle (powder) may burn and oxidize to, for example, become CO₂ as part of the exhaust gases. Optionally, the fuel mixture may contain ignition particles that may create at least one spark between them when absorbing EM energy. A fuel mixture, for example a lean fuel mixture, containing ignition particles that spreads homogeneously in the volume of the combustion chamber may ignite due to sparks in the combustion chamber, thus ignite portions of the fuel mixture simultaneously or nearly simultaneously. In some embodiments. The EM energy absorbing material may be selected to affect one or more ignition characteristics of the fuel mixture.

In some embodiments, the combustion chamber may include one or more injectors for injecting EM energy absorbing material into the chamber. In some embodiments, the fuel mixture may be mixed with the EM energy absorbing material prior to injection into the combustion chamber.

Reference is now made to FIG. 10. In some exemplary embodiments, the combustion chamber may be a cylinder in an engine (e.g., a car engine). For example, cylinder 1000 in FIG. 10. Cylinder 1000 may comprise a cylinder body 1010 (e.g., the combustion chamber), a piston 1020 and a connecting rod 1030 which may convert the vertical movement of piston 1020 to a rotational movement of a camshaft (not shown in FIG. 10). A fuel mixture may be injected to cylinder body 1010 when valve 1070 opens injector 1040. Alternatively, fuel may be sprayed to the cylinder via injector 1040 and air or other gases may be added from an additional intake (not shown in FIG. 10). The timing of the fuel or fuel mixture injection may be controlled by at least one processor (e.g., processor 92 or processor 2030) configured to control valve 1070, for example according to a feedback (e.g., a load of the engine, the torque and/or the position of the piston). Exhaust gas(s) outlet 1050 may be located in an upper part of the cylinder and may allow products of the combustion reaction (e.g., exhaust gas(s)) to flow out of the cylinder to a converter (e.g., catalytic converter) or other filter, when valve 1060 opens, for example, at the end of the combustion cycle. Cylinder 1000 may also comprise at least one radiating element 1080 configured apply or emit EM energy to the fuel mixture in the cylinder, for example, at a plurality of MSEs. The same processor and/or a different one may control the energy application to the fuel mixture via radiating element(s) 1080 by controlling the timing of the EM energy application and/or the power of the energy application and/or the duration of the energy application or the spatial distribution of the EM energy application in cylinder body 1010. EM energy may be applied to the cylinder at each cycle, several times during the cycle, or to one or more but not all of the cycles. The timing and/or duration of the EM energy application can be at any time during the stroke of the piston for any desired duration, for example, according to the requirements of the engine and the operating regime of a particular engine (e.g., diesel engine, gasoline engine or HCCI engine). Some examples for operation regimes (e.g., ignition states) are: cold start, cruising and accelerating. For example, cold start of the engine may require application of EM energy for a longer period than in cruising regime. In an acceleration regime, the timing of the EM energy application may set so that EM energy application occurs when the piston is in a lower position in the cylinder than the position where EM energy application occurs during cruising or cold start.

The processor may further be configured to receive an EM feedback, optionally the EM feedback is indicative of the energy absorbable in the fuel mixture. The processor may further be configured to adjust the EM energy application to the fuel mixture based on the received EM feedback, for example, as indicated in step 306 of method 300. Additionally or alternatively, the processor may be configured to adjust the EM energy application based on other feedbacks. The feedback may be related to at least one of: the rotational velocity of the engine, the engine's load, the cylinder walls temperature, surrounding temperature, location of the piston in a stroke, minimizing knocking and/or humidity level. In some embodiments, one or more sensors (not illustrated) may be provided inside or in the surrounding of the cylinder 1000, the engine or other parts of the vehicle. The sensors may be used to generate feedback, for example, of the kind used in method 300.

The processor may be further configured to adjust EM energy application in order to maximize the efficiency of the engine operation in accordance with the rotational velocity of the engine and the pressure in the cylinder. The processor may calculate the velocity/pressure operation cycle for a particular engine (e.g., auto cycle for gasoline engine and Diesel cycle for diesel engines) and optimize the EM energy application such that a large or maximum energy may be released in the combustion reaction, optionally without causing uncontrolled ignition and pressures high enough to harm the engine.

In some embodiments, the EM energy application to the combustion chamber (e.g., cylinder 1000) may involve determining a plurality of EM field patterns through which the EM energy is to be applied to the fuel mixture in the combustion chamber. The field patterns may be determined based on a feedback, for example a feedback related to: at least one aspect of the fuel mixture (e.g., the air/fuel ratio), at least one aspect of the combustion chamber (e.g., the position of the piston), or at least one aspect of the engine (e.g., the torque). The feedback may be associated with one or more portions of the combustion chamber. The feedback may be an EM feedback. Additionally, a weight (e.g., the power level and/or the duration of energy application) may be determined (e.g., by the processor) to each of a plurality of EM field patterns, optionally based on the feedback. A processor (e.g., processor 92 or processor 2030) may be configured to control the application of the plurality of EM field patterns at the determined weights, for example via at least one radiating element (e.g., element 1080).

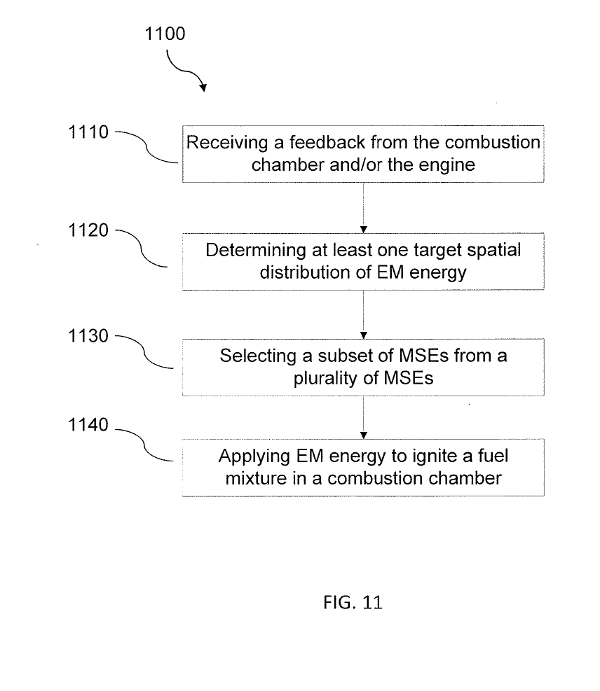

Reference is now made to method 1100 presented in FIG. 11 for applying EM energy to ignite a fuel mixture in a combustion chamber in an engine in accordance with some embodiments of the invention. A feedback may be received, for example from the combustion chamber (e.g., cylinder 1000) and/or the engine and/or a vehicle comprising the engine. The feedback may be related to: the type of the fuel (e.g., gasoline or diesel), the fuel/oxidizer ratio, the fuel mixture, the temperature of the fuel, the temperature of the combustion chamber, a position of a component of an engine with respect to the chamber (e.g., the position of piston 1020 in cylinder body 1010), a torque of the engine, a rotational speed of the engine, a composition of the combustion products (e.g., the exhaust gases) etc. In some embodiments, the feedback may be detected from the radiating element(s) (e.g., elements 1080) provided in the combustion chamber, acting as receivers.

In some embodiments, at least one target spatial EM energy distribution may be determined in step 1120. The spatial distribution may be determined based on any know method, for example method 500 presented in FIG. 5. The spatial distribution may be determined by known characteristics of combustion chamber and/or the fuel mixture. For example, the spatial distribution may be determined such that EM energy may be applied to the upper portion of a cylinder in a combustion engine, to cause homogeneous ignition throughout the cylinder's cross section. Additionally or alternatively, the spatial distribution may be determined based on a feedback, for example the feedback received in step 1120. In some exemplary embodiments, the spatial distribution may be determined based on the relative position of piston 1020 in cylinder 1000. In some embodiments, determining spatial distribution of EM energy may include selecting one or more field patterns at which EM energy is to be applied. Additionally, a weight may be determined to be applied to each of a of the one or more EM field patterns.

In some embodiments, a subset of MSEs (e.g., a single MSE) may be selected from a plurality of MSEs, in step 1130. The subset may be selected based on characteristics of the EM energy application apparatus, for example available frequency bandwidth (e.g., a single frequency 2.45 GHz or 850-900 MHz). In yet another example, a processor may determine to apply the EM energy (e.g., at the RF range) to one or more radiating elements, when the apparatus includes more than one radiating element. In some embodiments, the subset of MSEs may be determined based on a feedback, for example the feedback received in step 1110. In some embodiments, the subset of MSEs may be selected to provide at least one spatial EM energy distribution, for example the spatial distribution determined in step 1120. In some embodiments, the feedback may be MSE dependent. The processor may be configured to select the subset of MSEs, a power level and/or duration of EM energy application at each MSE based on the EM feedback at that MSE.

EM energy may be applied to the fuel mixture to ignite the fuel mixture in the combustion chamber, in step 1140. A processor (e.g., processor 92 or 2030) may be configured to control the EM energy application based on the feedback received in step 1110. For example, the processor may be configured to determine the timing of the EM energy application based on the position of the piston, or the rotational speed of the engine. Additionally or alternatively, the processor may be configured to control the EM energy application such that the spatial EM energy distribution determined, in step 1120, may be provided to the fuel mixture. In some embodiments, the processor may be configured to cause the application of the EM energy at the subset of MSEs, selected in step 1130. In some embodiments, the processor may be configured to cause the application of the EM energy at the subset of MSEs, at the respective power and/or duration at each MSE. In some embodiments, the processor may be configured to cause the application of the EM energy by supplying EM energy to the radiating element(s) from a source (e.g., source 96).

In some embodiments, the EM energy may be applied such that multiple nidus for ignition are applied into a volume of a fuel mixture (e.g., in a combustion chamber)—such that, at each desired ignition location, the EM energy may be applied above minimal energy to cause a local ignition of the fuel mixture. In some embodiments, EM energy may be applied such that a plurality of high intensity areas may be created in the volume of a fuel mixture, e.g., 100, 200, 300, 1000 or 2000 high intensity areas. In some embodiments, EM energy may be applied such that a plurality of nidus for ignition may be created in the volume of a fuel mixture, e.g., 100, 200, 300, 1000 or 2000 niduses. In some embodiments, multiple ignition nidus may be generated by applying EM energy such that a plurality of high intensity areas may be created in the volume of a fuel mixture (e.g., at a plurality of sub-regions in the combustion chamber), such that the fuel mixture may receive the needed energy to cause local ignition in certain locations (e.g., at a location of one or more of the high intensity areas, at the plurality of sub regions, etc.). As used herein, the term ‘nidus’ may refer to a place (e.g., a location in the combustion chamber—for example, a sub-volume or sub-region of the combustion chamber) where local ignition may be developed, generated or originated. ‘nidus’ may also refer to a place (e.g., a location in the combustion chamber—for example, a sub-volume or sub-region of the combustion chamber) where high intensity area(s) may be excited or applied in order to obtain, develop or generate local ignition. The plurality of high intensity areas may be created in the volume of a fuel mixture (e.g., at a plurality of sub-regions in the combustion chamber) simultaneously or at different times. In some embodiments, the plurality of high intensity areas may be of the same size or may have different sizes, e.g., different sizes of high intensity areas may be required for different fuel mixtures. In some embodiments, the size of the high intensity areas may be of the order of 1 mm, 3 mm, 1 cm or a different size. The plurality of high intensity areas created in the volume of a fuel mixture at different times may be random or may follow a predefined path (e.g., the progression of a front of the combustion reaction, propagation wave etc, . . . ). EM energy may be applied such that the energy may interact with the material located at the high intensity area (e.g., gas/fuel mixture, vapor, solid etc,) which may cause a thermal effect, such that the heat generated at that area is greater than that is lost to the surrounding matter, when the heat of that area is higher than the ignition temperature such that ignition is obtained in that area (e.g., sub region of the combustion chamber) and a chemical reaction may be activated. The result of the chemical reaction (e.g., interaction of the fuel and the air) may cause a local activation that may either cause activation of neighbor gas such that the ignition process may propagate to remote areas in the combustion chamber. In lean mixtures, the location of the next gas molecule may be far apart such that propagation is not possible. In some embodiments, the location(s) of the local ignition(s) (e.g., ignition at a sub-region of the combustion chamber) and/or the timing of one or more local ignition(s) may be controlled based on one or more parameters. For example, such parameters may include a momentary size of the combustion chamber (as the piston moves within the cylinder—the size of the combustion chamber changes in accordance with the piston's movement), the load on the engine, one or more characteristics of the fuel or fuel mixture, a desired efficiency, a desired pollution level, a desired temperature of combustion or additional parameters. In some embodiments, EM energy may be applied such that a desired location(s) of the local ignition(s) (e.g., ignition at a sub-region of the combustion chamber) and/or the timing of one or more local ignition(s) may be obtained. In some embodiments, the use of the lean fuel mixture may be facilitated by obtaining or exciting a plurality of local ignition(s) in the combustion chamber.

In some embodiments, a gas mixture in the cylinder may be brought to a certain energy state or condition (e.g., via compression or other means) to avoid ignition. In this such condition, obtaining or exciting a plurality of local ignition(s) in the combustion chamber may trigger a combustion reaction of the gas/fuel mixture in the cylinder. However, propagation of the ignition wave (e.g., the progression of a front of the combustion reaction) may relatively slow (e.g., in the range 5-50 m/sec). In some embodiments, the timing of one or more additional local ignition(s) may be obtained or controlled such that it may occur earlier than the indigenous propagation wave. This may allow accelerated ignition and/or control of the ignition such that the combustion may take place in an optimal fashion or in efficient manner (e.g., completing the ignition or full combustion before the piston reached its nadir).

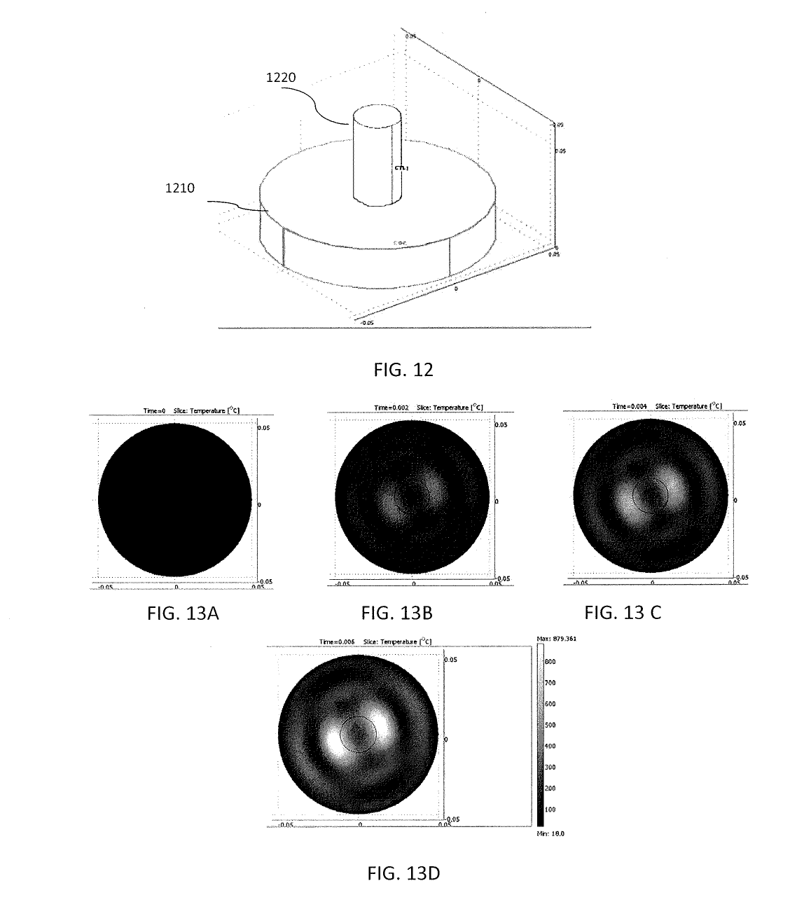

Reference is now made to FIG. 12. Experimental simulation of EM energy application to a cylinder was accomplished using COSMOL software. A steel gasoline cylinder 1210 having 100 mm diameter was chosen for the simulation, as illustrated in FIG. 12. The simulation assumed the following parameters: EM energy application is done at maximum fuel mixture compression, which occurs when the piston position is 20 mm from the top of the cylinder. A circular steel wave guide 1220 (diameter 20 mm and 45 mm long) filled with dry air was chosen as the radiating element. A power of 1000 W was simulated to be applied for 6 milliseconds (ms) in order to elevate the temperature of the fuel mixture above the 700° C. threshold needed to ignite the fuel in a reasonable combustion rate. In the simulation, excitation was simulated by EM energy at frequencies that are highly absorbable by the cavity (i.e., the cylinder body) (S11<−20 dB).

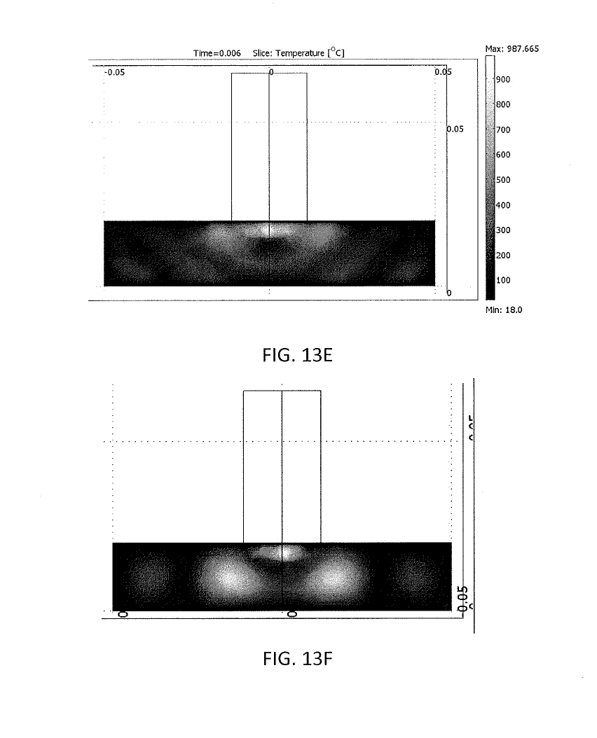

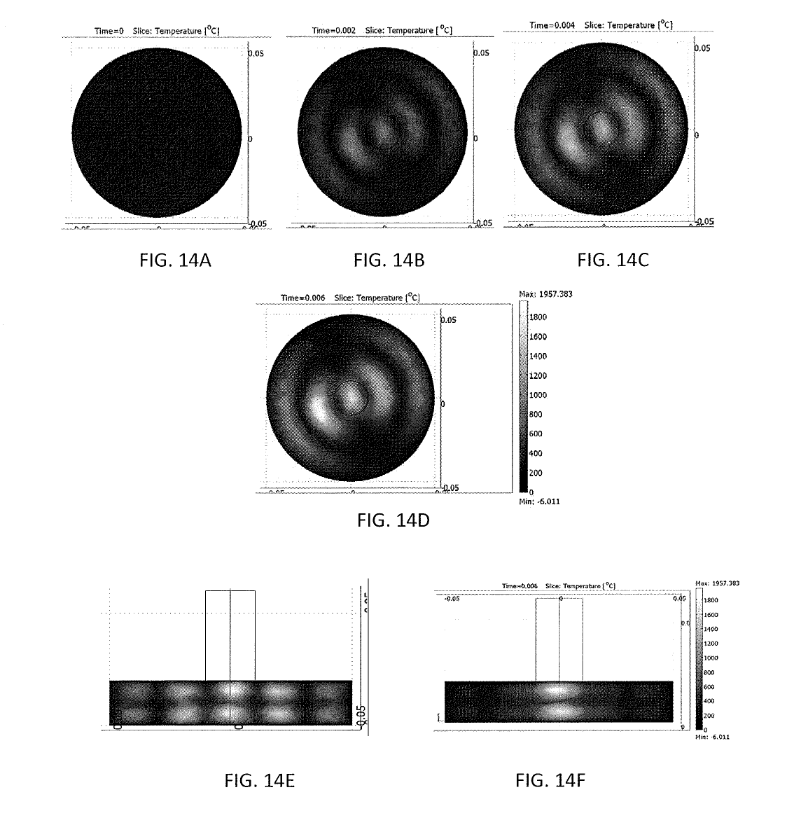

A gasoline fuel mixture having a near stoichiometric ratio 14:1 was simulated to be injected to the cylinder in the first simulation. The dielectric properties of the fuel mixture were ∈r=1.01−i·0.008 (tan δ˜0.0079). The thermal properties were as follows: initial temperature 25° C., thermal conductivities of the fuel mixture 0.03 (W/m·oK) and the cylinder 400 (W/m·oK), density of the fuel mixture 59 kg/m³, specific heat of the mixture 1.08 J/kg·oK and heat transfer coefficient of the cylinder material 200 W/m²·oK. The convection heat transfer physics module was used at pressure of 10 atm. The simulated temperature profiles developed in the fuel mixture due to EM energy application at two different frequencies are illustrated in FIGS. 13 and 14. The simulated temperature profiles developed due to excitation of EM energy at 10.45 GHz are presented in FIGS. 13A-13F. The time evolution of the temperature profile in the X-Y plane 5 mm from the piston from 0 to 6 ms is presented in FIGS. 13A (t=0), 13B (t=2 ms), 13C (t=4 ms) and 13D (t=6 ms). A temperature scale bar is presented in the right part of FIG. 13D. The light grey and white shades in the temperature scale bar correspond to temperatures higher than 700° C.

It can be seen that at 6 ms, due to high EM field intensities, high temperatures developed mainly in the central part of the cylinder and in some peripheral areas. The temperature profile at 6 ms in the X-Z plane is presented in FIG. 13E and in the Y-Z plane in FIG. 13F, showing high temperature maxima in the central upper part of the cylinder with some peripheral temperature maxima towards the cylinder wall. Similar simulation was done for EM energy at frequency of 16.95 GHz and presented in FIGS. 14A-14F. The time evolution of the temperature profile from 0-6 ms in the X-Y plane at a distance of 5 mm from the piston is presented in FIGS. 14A-14D. The temperature profiles after 6 ms in the X-Z plan and the Y-Z plan are presented in FIGS. 14E and 14F. The high temperature profile that developed due to excitation of EM energy at 16.95 GHz is more uniform than the one developed due to excitation of EM energy at 10.45 GHz. High temperature areas developed in open rings from the center towards the cylinder wall (as can be seen in FIGS. 14A-14D). In the X-Z plan, uniform distribution of high temperature areas is shown in the entire plane (FIG. 14E), while in the Y-Z plane two high temperature areas were developed in the central part of the cylinder (FIG. 14F). A similar temperature profile that may develop in a real cylinder may result in very controlled and efficient ignition.

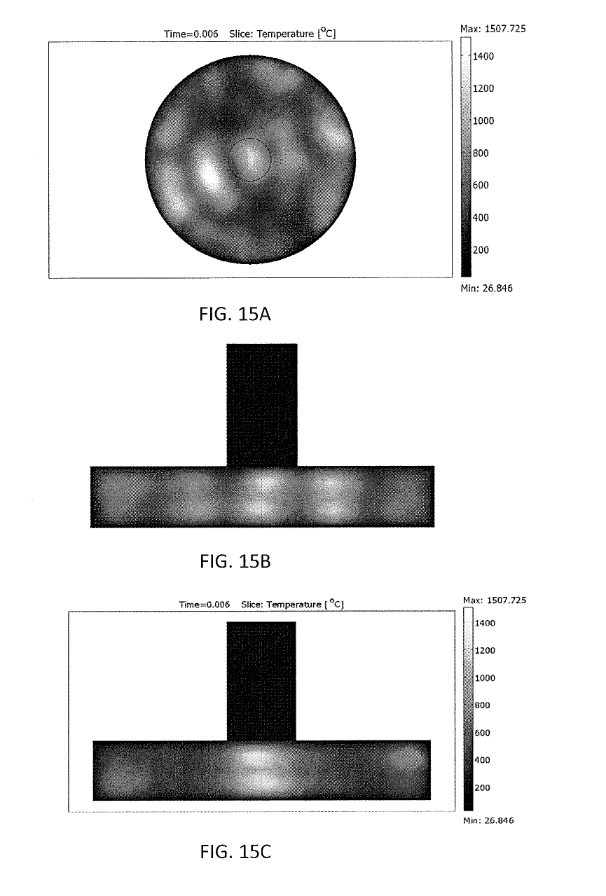

Another heating simulation was done using the same cylinder and the same radiating element, as illustrated in FIG. 12. EM energy was applied to a cylinder containing very a lean gasoline fuel mixture with air/fuel ratio of 100:1. A power of 4000 W was used to heat up the lean mixture to above 700° C. FIGS. 15A-15C presents the temperature profile that developed during the excitation of EM energy having a frequency of 16.95 GHz. The dielectric constants of the lean mixture were ∈r=1.0016−i·2.6·10−4 (1.01−i·8·10−3). The mixture thermal conductivity was 0.025 W/m·oK. The mass density of the mixture is 8.3 kg/m3 and the specific heat of the mixture is 1.024 kJ/kg·oK. FIG. 15A shows the temperature profile in the X-Y plane in the cylinder after 6 ms of EM energy application, a temperature scale bar is presented in the right end of the figure. Substantially uniform distribution of the temperature profile across the entire cross section of the plane can be observed. High intensity spots of 800-1400° C. are evenly distributed. Similar behavior can be observed at the X-Z plane (FIG. 15B), and Y-Z plane (FIG. 15C). In order to uniformly ignite very lean fuel mixtures, a spatial application and absorption of EM energy as shown in the simulation presented in FIGS. 15A-15C may be favorable.

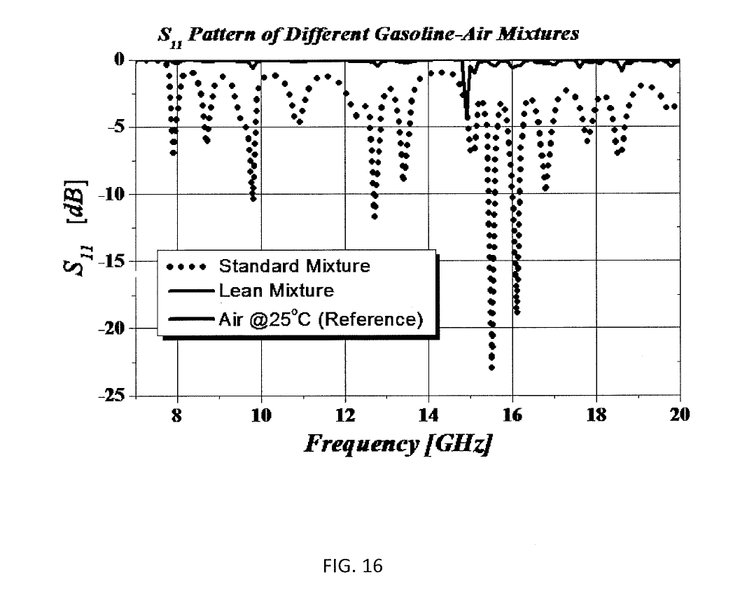

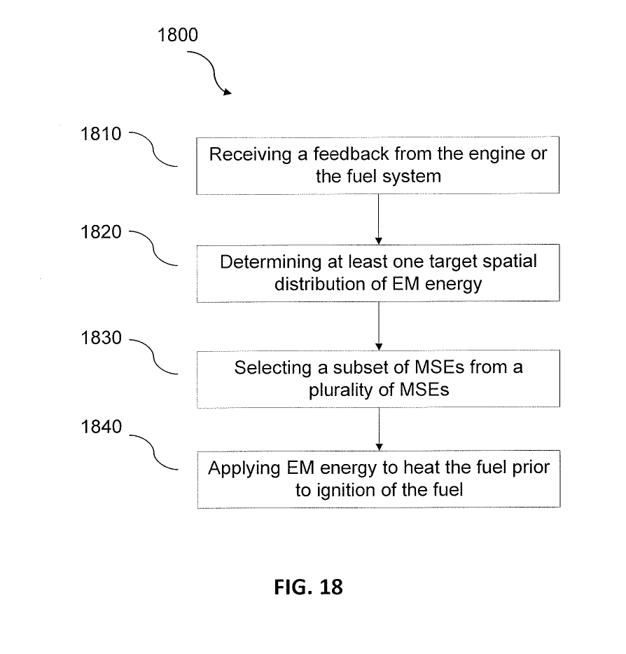

In another heating simulation, variation of the S11 parameter due different fuel mixtures and piston positions was simulated. FIG. 18 shows variation in the S11 parameter (which may, for example, represent the reflection coefficient, as described above) as a function of the frequency of EM energy (e.g., in the RF range) due to use of different fuel mixture ratios in comparison to air. The cylinder used to create the data in FIG. 16 is the same cylinder in the previous simulations described above (i.e., in the context of FIG. 12). Table 1 shows the dielectric properties (∈′ and ∈″) for two different fuel mixtures (e.g., two fuel mixtures having different air/fuel ratios) and air.

TABLE 1

| Material | ∈’ | ∈‘’ |
|---|---|---|
| Near Stoichiometric “Standard” | 1.01 | 8e−3 |
| Mixture (14:1) | | |
| Extreme Lean Mixture (100:1) | 1.0016 | 2.4e−4 |
| Air@25° C. (Reference) | 1.0005 | 1e−5 |

The highest EM energy absorption was observed in the Near Stoichiometric “Standard” Mixture, in particular in frequencies of 15.5 GHz and 16.05 GHz. The lean fuel mixture showed lower EM energy absorption, in comparison to the Near Stoichiometric “Standard” Mixture. However in 14.95 GHz, the simulation showed relatively good energy absorption for the lean fuel mixture. Detecting the S11 parameter of a fuel mixture may allow identifying the air/fuel ratio and/or chemical composition of the fuel mixture by comparing the detected S11 to a data stored in look-up table or by any other means (e.g., a formula). The data (e.g., data in the look up table) may be stored on a memory (e.g., a memory in connection with processor 92 or processor 2030) or at any other location. Detecting online variation in the fuel mixture (e.g., by detecting S11 parameter) may allow using a plurality of fuel mixtures during an operation of a single engine. The EM energy application may be adjusted in accordance with the properties of the fuel mixture. The adjustment may be performed at any time during each cycle, for example, periodically after a certain number of cycles, every time the load in the engine changes and/or every time a change in the fuel mixture may be required.

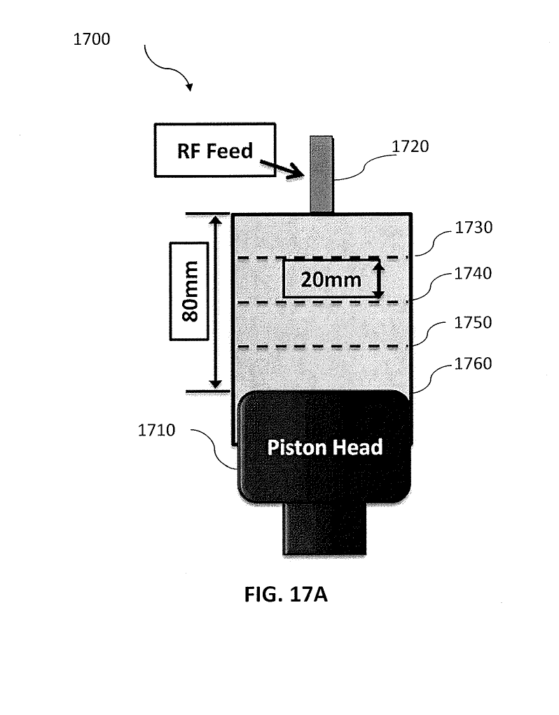

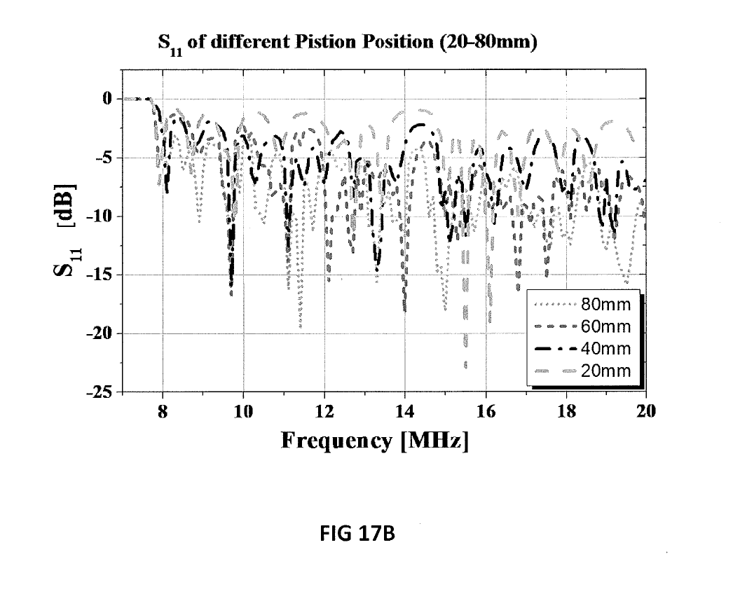

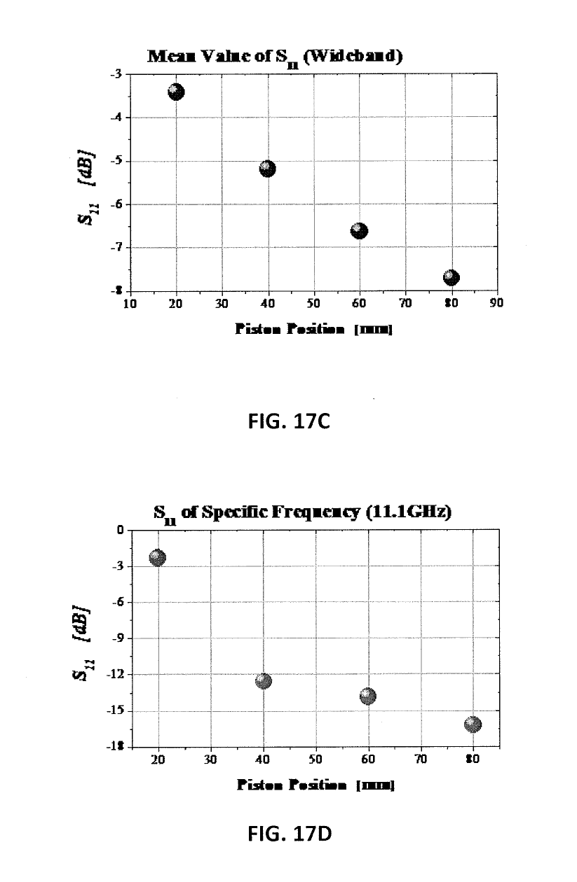

Reference is now made to FIG. 17A that illustrates a cylinder 1700 according to some embodiments of the invention. FIG. 17A illustrates, in particular, several optional positions for piston 1710 in comparison to a top of cylinder 1700 and RF feed (radiating element) 1720. Positions 1730, 1740, 1750 and 1760 illustrate piston 1710 distanced from the top of cylinder 1700 at 20 mm, 40 mm, 60 mm and 80 mm respectively. FIG. 17B shows simulation results of the reflection coefficient (S11 parameter) for different piston positions simulated for 14:1 fuel mixture ratio as a function of the frequency of EM energy. The S11 parameter was calculated as the power applied to the cylinder minus the power reflected from the cylinder divided by the power applied to the cylinder:

S11=(Papplied−Preflected)/Papplied

Different positions of the piston during a stroke may result in different EM energy absorption peaks (e.g., different peaks or maxima) at different frequencies. For example, as illustrated in FIG. 17B, the highest absorption peak or maximum absorption for the 80 mm piston position was at approximately 11.5 GHz. The highest peak or maximum absorption for 60 mm occurred at approximately 14 GHz. The highest peak or maximum absorption for 40 mm occurred at approximately 9.75 GHz. The highest peak or maximum absorption for the 20 mm piston position occurred at approximately 15.5 GHz. Detection of changes in S11 may indicate locations of the piston during the cylinder stroke. Another embodiment for detecting the piston position by measuring the S11 parameter is shown in FIG. 17C. The mean value of all S11 parameters in a given frequency band are plotted versus the piston position. As can be seen in FIG. 17C, a substantially linear relationship between the piston position and the mean value of S11 parameter was obtained in the simulation. Generally, the higher the piston position, the higher the value of the mean value of S11 and the lower the value of the EM energy absorption. In some embodiments, the mean value of S11 may be calculated based on a received S11 feedback and the piston position may be determined, e.g., by comparing the mean value of S11 to piston positions from a lookup table located in a memory. In some embodiments, EM energy application may be controlled and/or adjusted based on the piston position. Another method to correlate between S11 parameter and the piston's position is to calculate S11 parameter for a particular frequency. An example of this method is shown in FIG. 17D for a frequency of 11.1 GHz. The simulation shows that, the higher the position of the piston the higher the value of the S11 parameter and the lower the value of the EM energy absorption, for a particular frequency. The detection may be done whenever detection of the piston position is required, such as, for example, several times during a combustion cycle. In some embodiments, S11 (an example EM feedback) may be detected at a particular frequency (e.g., by applying EM energy at that frequency to the cylinder) and piston position may be determined, e.g., by comparing the value of S11 to piston positions from a lookup table located in a memory. In some embodiments, EM energy application may be controlled and/or adjusted based on the piston position.

In some embodiments, the EM energy may be applied to cause a substantially complete combustion of the fuel or fuel mixture either by pre-heating and/or by igniting the fuel or fuel mixture according to some embodiments of the invention. In substantially complete combustion, the amount of CO emitted in the exhaust gas(s) may be small. CO may serve as an oxidizer in the decomposition processes of NOₓ. Due to the substantially complete combustion, the amount of CO in the exhaust gas(s) may be small (e.g., on order of ppm).

Preheating a Fuel

Other embodiments of the invention may include an apparatus and method for applying EM energy to a fuel or a fuel mixture for pre-heating the fuel or the fuel mixture prior to ignition. The fuel or the fuel mixture may be injected to a combustion chamber from a fuel system. The fuel system may be in a fluid connection to the combustion chamber and/or may be a part of an engine, optionally an engine of a vehicle. EM energy may be applied via at least one radiating element configured to apply EM energy. At least one processor (e.g., processor 92 or processor 2030) may be configured to control the EM energy application to the fuel or the fuel mixture, for example according to method 1800, presented at FIG. 18, in accordance with some embodiments of the invention. A feedback may be received, optionally from the fuel system or the engine, in step 1810. The feedback may be related to at least one aspect of the fuel or the fuel mixture, at least one aspect of the fuel system or at least one aspect of an engine comprising the fuel system. For example the feedback may be related to the fuel type, the fuel temperature, the fuel consumption, the ignition timing of the combustion chamber. The feedback may be an EM feedback. The EM feedback may be indicative of EM energy absorbable by the fuel mixture or the fuel at a plurality of MSEs or at a single MSE (e.g., at a single frequency). The processor may be further configured to adjust or control the EM application via a plurality of MSEs based on the received feedback. The processor may be further configured to adjust the EM application by controlling the power and or time duration of energy application at each MSE. The processor may be further configured to adjust the EM application by applying a target spatial distribution of EM energy (e.g., by selecting one or more field pattern and optionally a respective weight for each field pattern).

In some embodiments, an EM energy application apparatus, optionally for applying EM energy in the RF range, may be provided in a diesel engine in order to pre-heat the diesel before injection to the combustion chamber. In some embodiments, pre-heating the diesel may reduce the size of the droplet formed and/or may reduce an ignition delay. In some embodiments, reduced ignition delay may result in increased efficiency, reduced pollution level, reduced noise or any combination thereof.

In some embodiments, pre-heating may assist the ignition of fuel mixture and may allow better ignition timing and higher combustion efficiency. The pre-heating process may take place in the combustion chamber (e.g., cylinder 1000) after injection of the fuel mixture or spraying the fuel additionally or alternatively EM energy may be applied to the fuel or the fuel mixture prior to the injection and/or spraying to the combustion chamber. At least one radiating element (e.g., element 102, 18 or 16) may be placed in proximity to a fuel or fuel mixture pipe (e.g., the pipe in which the fuel or fuel mixture flow, thus may be regarded as the energy application zone).

In some embodiments, the pipe may have at least one window made from a material transparent to EM energy so that EM energy may be transferred from the radiating element to the interior of the pipe. Alternatively, the fuel/fuel mixture pipe may be constructed from or include a material transparent to EM energy. The radiating element may be a slow-wave antenna or a leaky wave antenna attached to the fuel/fuel mixture pipe for applying EM energy along a certain distance along the pipe. Optionally, the energy application zone may be an intermediate pre-heating chamber and may be added to the system for pre-heating the fuel/fuel mixture. The intermediate chamber may have at least one radiating element (e.g., radiating element 102, 18 or 16) located inside the chamber or may have at least one window made from a material transparent to EM energy. Alternatively, the intermediate chamber may be made from a material transparent to EM energy. EM energy may be applied to the fuel or fuel mixture prior to injecting via an injector (e.g., injector 1040) to the combustion chamber (e.g., cylinder 1000).

The radiating element(s) may be placed inside the pipe, such that there may be a direct contact between the fuel/fuel mixture to be heated and the element. Such direct contact may allow heating the fuel with RF energy at frequencies that are evanescent in an empty pipe (e.g., in the absence of the fuel/fuel mixture), but resonant in a fuel-filled pipe. Such frequencies may be referred to as “load-resonances” (e.g., which corresponds to the resonance frequency of the fuel/fuel mixture). In some embodiments, EM energy may be applied at load-resonance frequencies for fuel mixture in the cylinder to either pre-heat or ignite the fuel mixture.

In some embodiments, a target spatial EM energy distribution may be determined, in step 1820. The spatial distribution may be determined according to any known method, for example method 500, disclosed in FIG. 5. The spatial distribution may be determined by known characteristics of fuel system and/or the fuel. For example, the spatial distribution may be determined such that EM energy may be applied along a predetermined length of a pipe containing the fuel mixture. Additionally or alternatively, the spatial distribution may be determined based on a feedback, for example the feedback received in step 1820. In some exemplary embodiments, the spatial distribution may be determined based on the type of the fuel. In some embodiments, determining spatial distribution of EM energy may include selecting one or more field patterns at which EM energy is to be applied. Additionally, a weight may be determined to be applied to each of a of the one or more EM field patterns.

In some embodiments, a subset of MSEs (e.g., a single MSE, or two or more MSEs) may be selected from a plurality of MSEs, in step 1830. The subset may be selected based on characteristics of the EM energy application apparatus, for example available frequency bandwidth (e.g., single frequency 2.45 GHz or 850-900 MHz). In some embodiments, the subset of MSEs may be determined based on a feedback, for example the feedback received in step 1810. For example the subset of MSEs may be determined based of EM feedback received from the fuel. In some embodiments, the subset of MSEs being selected to provide at least one spatial EM energy distribution, for example the spatial distribution determined in step 1820.

EM energy may be applied to heat or per-heat the fuel or the fuel mixture, in step 1840. The EM energy may be applied to the fuel system, e.g., a pipe containing the fuel, or to the combustion chamber prior to ignition. In some embodiments, a processor (e.g., processor 92 or processor 2030) may be configured to control the EM energy application based on the feedback received in step 1810. For example, the processor may be configured to determine the timing of the EM energy application based on the position of the piston (i.e., the position of the piston may indicate the ignition time), or the flow speed of the fuel in the pipe. Additionally or alternatively, the processor may be configured to control the EM energy application such that the spatial EM energy distribution determined in step 1820, may be provided to the fuel or the fuel mixture. In some embodiments, the processor may be configured to cause the application of the EM energy at the subset of MSEs, selected in step 1830. In some embodiments, the processor may be configured to cause the application of the EM energy at the subset of MSEs, at the respective power and/or duration at each MSE. In some embodiments, the apparatus may be configured to cause the application of the EM energy by supplying EM energy to the radiating element(s) from a source (e.g., source 96)

Some embodiments may apply EM energy to a cylinder during initial ignition of the engine, also known as “cold start.” During cold start the temperatures of the fuel mixture, injectors (e.g., injector 1040) and cylinder walls (e.g., cylinder body 1010) are substantially similar to the ambient temperature, or temperature of the surrounding environment. The temperature of the surrounding environment may vary, for example, between −20° C. to +40° C. However, in comparison to the combustion temperature (e.g., 700° C.-1300° C.) even the highest temperature in this range, 40° C., may still be considered a relatively low temperature. The cylinder body 1010 is often the largest (in comparison to, for example, the fuel mixture and the injector 1040) of the components at the temperature of the surrounding environment during a cold start. For this reason, the cylinder body 1010 often has the largest heat capacity and, thus, may act as a “heat sink” to cool combustion reactions that may take place in the cylinder body. In order to ignite an engine during cold start, richer fuel mixtures may be required to start the combustion reaction. In some embodiments, EM energy may be applied to the cylinder in order to pre-heat the fuel mixture. For example, EM energy may be applied to sub-volumes of the fuel mixture located in proximity to walls of the cylinder body 1010. Applying EM energy to sub-volumes of the fuel mixture located in proximity to walls of the cylinder body 1010 may prevent heat convection from the walls of the cylinder body 1010 and, thus, may increase the efficiency of the combustion reaction. Such increases in efficiency may, in some cases, allow the use of near stoichiometric fuel mixtures or even lean fuel mixtures.

HCCI engines have ability to increase or decrease power at multiple operation regimes, e.g., at cold start or acceleration. One way to increase or decrease power in HCCI engines may be to thermally stratify the fuel mixture such that different points in the compressed fuel mixture have different temperatures and may ignite at different times, thus modifying the heat release rate which may make it possible to increase and decrease power.

In some exemplary embodiments, the combustion chamber may be cylinder of an HCCI engine and the EM energy application may be configured to pre-heat a lean fuel mixture prior to injection to the cylinder (e.g., cylinder 1000), for example in order to accelerate the combustion reaction in the lean mixture, which may allow or facilitate better timing of the ignition. Additionally or alternatively, EM energy may be applied to the fuel mixture inside the combustion chamber either to pre-heat the lean fuel mixture or to ignite the lean fuel mixture. The processor may be further configured to adjust the EM energy application to lean mixture such that a large volume of the fuel mixture may absorbed the EM energy required to either pre-heat or ignite the lean fuel mixture. Optionally, a pre-determined amount of EM energy may be applied in order to elevate the temperature of the fuel mixture to a desired temperature (e.g., an ignition temperature). In some embodiments, EM energy may be applied to pre-heat the fuel or fuel mixture in order to control the free radicals in the fuel and/or fuel mixture. The amount of free radicals in the fuel or fuel mixture may control or assist in controlling a reactivity characteristic of the fuel or the fuel mixture (e.g., its temperature ignition, its reaction rate), thus control for example the timing of the ignition.

In the foregoing Description of Exemplary Embodiments, various features are grouped together in a single embodiment for purposes of streamlining the disclosure. This method of disclosure is not to be interpreted as reflecting an intention that the claimed invention requires more features than are expressly recited in each claim. Rather, as the following claims reflect, inventive aspects lie in less than all features of a single foregoing disclosed embodiment. Thus, the following claims are hereby incorporated into this Detailed Description, with each claim standing on its own as a separate embodiment of the invention.

Moreover, it will be apparent to those skilled in the art from consideration of the specification and practice of the present disclosure that various modifications and variations can be made to the disclosed systems and methods without departing from the scope of the invention, as claimed. For example, one or more steps of a method and/or one or more components of an apparatus or a device may be omitted, changed, or substituted without departing from the scope of the invention. Thus, it is intended that the specification and examples be considered as exemplary only, with a true scope of the present disclosure being indicated by the following claims and their equivalents.

1. An apparatus for igniting a fuel mixture by applying radio frequency (RF) energy, via at least one radiating element, to a combustion chamber, the apparatus comprising:
at least one processor configured to:
determine at least one spatial distribution of RF energy to be achieved during application of RF energy to the fuel mixture for igniting the fuel mixture; and
control energy application to the fuel mixture, via the at least one radiating element, to provide the at least one spatial distribution of RF energy application.

2. The apparatus of claim 1, wherein the processor is further configured to control application of RF energy to the fuel mixture based on a feedback

3. The apparatus of claim 2, wherein the feedback is related to at least one aspect of the fuel mixture.

4. The apparatus of claim 1, wherein the processor is further configured to select a subset of Modulation Space Elements (MSEs) from among a plurality of MSEs at which RF energy from the at least one radiating element can be applied, the selected subset of MSEs being selected to provide the at least one spatial distribution of RF energy, the MSEs referring to adjustable parameters of the apparatus which affect a field pattern in the combustion chamber.

5. The apparatus of claim 4, wherein determining the at least one spatial distribution of RF energy is based on a feedback.

6. The apparatus of claim 5, wherein the feedback is related to at least one aspect of the fuel mixture.

7. The apparatus of claim 2, wherein the feedback is an EM feedback received from the combustion chamber or an engine comprising the combustion chamber.

8. The apparatus of claim 7, wherein the EM feedback is indicative of EM energy absorbable in the fuel mixture.

9. The apparatus of claim 1, further comprising at least one radiating element configured to apply RF energy to the fuel mixture.

10. The apparatus of claim 5, wherein the feedback is selected from a group consisting of: a temperature of the fuel mixture in a combustion chamber, a temperature of a portion of the combustion chamber, geometry of the combustion chamber, a relative position of an engine component or a composition of the fuel mixture in the combustion chamber.

11. An apparatus for applying Radio Frequency (RF) energy to a combustion chamber for igniting a fuel mixture, via at least one radiating element, the apparatus comprising:
at least one processor configured to:
select a subset of Modulation Space Elements (MSEs) from among a plurality of MSEs at which RF energy from the at least one radiating element can be applied; and
control the application of RF energy to the fuel mixture, via the at least one radiating element such that the RF energy is applied for igniting the fuel mixture.

12. The apparatus of claim 11, wherein the processor is further configured to control application of RF energy to the fuel mixture based on a feedback.

13. The apparatus of claim 12, wherein the feedback is related to at least one aspect of the fuel mixture.

14. A method for applying Radio Frequency (RF) energy to ignite a fuel mixture in a combustion chamber, the method comprising:
determining at least one spatial distribution of RF energy to be achieved during application of RF energy to the fuel mixture; and
applying the RF energy application to the fuel mixture, via at least one radiating element such that the at least one spatial distribution of RF energy is applied

15. (canceled)

16. (canceled)

17. The method of claim 14, further comprising selecting a subset of Modulation Space Elements (MSEs) from among a plurality of MSEs at which RF energy from at least one radiating element can be applied, the selected subset of MSEs being selected to provide the at least one spatial distribution of RF energy.

18. The method of claim 14, further comprising receiving a feedback and determining the at least one spatial distribution of RF energy based on the received feedback.

19. The method of claim 18, wherein the feedback is related to at least one aspect of the fuel mixture.

20. The method of claim 18, wherein the feedback is an EM feedback.

21. The method of claim 14, further comprising controlling timing of the RF energy application.

22.-37. (canceled)

38. The apparatus of claim 11, wherein the processor is further configured to control a timing of the application of RF energy to the fuel mixture.
